(19) United States
(12) Patent Application Publication
(10) Pub. No.: US 2010/0265700 A1
(43) Pub. Date: Oct. 21, 2010

(54) FLOURESCENT LAMP SUPPORT

(75) Inventors: Greg Galluccio, Hauppauge, NY (US); Robert Quercia, Garden City, NY (US); Francisco Schapira, Valley Stream, NY (US); Ruel Sarino, Port Washington, NY (US)

Correspondence Address: Weiss & Arons, LLP, 1540 Route 202, Suite 8, Pomona, NY, 10970, US

(73) Assignee: Leviton Manufacturing Corporation, Little Neck, NY (US)

(21) Appl. No.: 12/770,468

(22) Filed: Apr. 29, 2010

Related U.S. Application Data
(63) Continuation-in-part of application No. 12/679,980.
Application No. 12/679,980 is a continuation-in-part of application No. 12/173,171, filed on Jul. 15, 2008.
(60) Provisional application No. 61/144,612, filed on Jan. 14, 2009.

(51) Int. Cl. F21V 21/00; F21V 19/00; H01J 9/24

(52) U.S. Cl. 362/217.13; 362/382; 445/23

(57) ABSTRACT

Apparatus and methods for supporting a fluorescent lamp. The apparatus may include an integrated ballast module. The integrated ballast module may include a ballast. The integrated ballast module may also include a housing having an exterior and an interior. The housing may be configured to support two or more lampholders exterior to the housing. The ballast may be located in the interior of the housing.

### CROSS-REFERENCE TO RELATED APPLICATIONS

This application is a continuation-in-part of co-pending U.S. application Ser. No. 12/679,980, filed on Mar. 25, 2010, under 35 U.S.C. §371. U.S. application Ser. No. 12/679,980 claims the benefit of U.S. Provisional Application No. 61/144,612, filed on Jan. 14, 2009, and U.S. Nonprovisional application Ser. No. 12/173,171, filed on Jul. 15, 2008, all of which are hereby incorporated by reference herein in their entireties.

### FIELD OF TECHNOLOGY

This application relates to apparatus and methods for supporting and powering fluorescent lamps. In particular, the application relates to apparatus and methods for distributing power from a ballast to a lamp holder.

### BACKGROUND OF THE INVENTION

Fluorescent lamp holders are typically installed in a sheet metal fixture with a ballast and associated wiring. The manufacturer will generally assemble the lamp holders to the sheet metal fixture, attach the ballast to the fixture, and run wires between the ballast and lamp holders. This process can be labor intensive and may lead to wiring errors and an unappealing installation.

FIG. 1 shows typical light fixture 100. Light fixture 100 may include enclosure 102. Enclosure 102 may be a fixture housing. Surface 103 of enclosure 102 may be a reflector. Surface 103 may have breaks in slope 105 to direct light in selected directions. Light fixture 100 may include lamp holders 104, 106 and 108. Lamp holders 104, 106 and 108 may each hold one end of a tube-type fluorescent lamp. The other end of each lamp may be held by lamp holders 110, 112 and 114, respectively. Arrows A, B and C show where fluorescent tubes would be placed between corresponding lamp holders. The lamp holders are fixed directly to enclosure 102.

FIG. 2 shows typical lamp holder 200. Lamp holder 200 may includes base 202, body 204, lamp pin guide 206 and pin slot 208. Paired contact pins from a fluorescent lamp may be inserted into slot 208 until the pins occupy positions 210 and 212. The pins may then be rotated in direction A about rotational axis X until the pins contact power terminals 214 and 216 (shown in broken line) inside body 204 of lamp holder 200.

Long wiring leads that may be required to provide power to typical lamp holder 200 in typical light fixture 100 may promote errors during assembly, transport or installation and may make lamp fixture assembly expensive with respect to both labor and materials. In addition, lamp holder 200 is typically mechanically secured to enclosure 102, making future adjustments of its position impossible.

It would be desirable, therefore, to provide apparatus and methods that improve the process of assembling lamp fixture components.

It would be further desirable, therefore, to provide apparatus and methods that reduce the likelihood of manufacturing errors.

### SUMMARY OF THE INVENTION

It is an object of the invention to provide apparatus and methods that reduce the likelihood of errors in the manufacture of lamp fixtures.

It is an object of the invention to provide apparatus and methods that reduce the labor in a light fixture housing.

Accordingly, apparatus and methods for supporting and energizing a lamp are provided. The lamp may be a fluorescent lamp or any other suitable lamp. The apparatus may include one, two or more ballast modules. Each ballast module may include a ballast. The ballast module may be removed from the fixture for replacement and/or reconfiguration. This may provide a lamp fixture that is modular in nature and a more efficient manufacturing process.

A lamp holder may be removably coupled to the ballast module. The lamp holder may be in electrical communication with the ballast contained in the ballast module such that when the ballast module supports a lamp, it is configured to provide power from the ballast to the lamp.

In some embodiments, the lamp holder may be permanently fixed to the ballast module. In such embodiments, the ballast may include ballast components that are permanently fixed on a printed circuit board that may be located inside the ballast module. The ballast may be at least partially enclosed in a ballast housing.

The ballast may include a rigid power distribution unit. The rigid power distribution unit may transfer power from the ballast to the lamp. Some embodiments, therefore, may not require the use of wires to transmit power from the ballast to the lamp holder. In other embodiments, wires may be used to transmit power from the ballast to the lamp holder. The lamp may be any suitable lamp, including the T5, T8 and T12 lamps.

In some embodiments of the systems and methods of the invention, the rigid power distribution unit may include a track that has conducting rails for supplying power to the lamp holders. The track may be used to position lamp holders at any desired spacing. In this embodiment, the track may be used in connection with fixture designs requiring different center-to-center lamp spacing.

In some embodiments, the rigid power distribution unit may include a printed circuit board. The lamp holder may clamp onto or be otherwise electrically connected to the printed circuit board and draw power from it. The printed circuit board may have traces for each lamp holder. In some embodiments, conductive buses may be used either as traces on the printed circuit board or separate from the printed circuit board.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a top view of a typical light fixture;

FIG. 2 is an elevational view taken along lines 2-2 shown in FIG. 1;

FIG. 3 is a perspective view of an apparatus in accordance with the present disclosure;

FIG. 4 is a perspective view of other apparatus in accordance with the present disclosure;

FIG. 5 is a perspective view of additional apparatus in accordance with the present disclosure;

FIG. 6 is a perspective view of additional apparatus in accordance with the present disclosure;

FIG. 6A-6C show perspective, top, and frontal views, respectively, of the apparatus shown in FIG. 6 with a cover removed;

FIG. 7 is a perspective view of an apparatus in accordance with the present disclosure;

FIG. 8 is a perspective view of the apparatus shown in FIG. 7;

FIG. 9 is a perspective view of additional apparatus in accordance with the present disclosure;

FIG. 10 is a perspective view of other apparatus in accordance with the present disclosure;

FIG. 11 is a partial cross-sectional view taken along line 11-11 shown in FIG. 10.

FIG. 11A is a perspective view of apparatus shown in accordance with the present disclosure;

FIGS. 12A and 12B are sectional views taken along line 12-12 shown in FIG. 11A;

FIGS. 13 and 13A are exploded perspective views of additional apparatus in accordance with the present disclosure;

FIGS. 14A, 14B and 14D are cross sectional views of apparatus in accordance with the invention. FIG. 14C is a partial cross-sectional view of apparatus in accordance with the present disclosure. FIG. 14E is a frontal view of additional apparatus in accordance with the present disclosure;

FIGS. 15A and 15B are frontal and side views, respectively, of a lamp holder that may be incorporated into any of the embodiments shown in FIGS. 3-6;

FIGS. 16A-16C show top, front, and side views, respectively, of a cover which may be used with any of the embodiments of the invention;

FIG. 17 is a schematic diagram of an apparatus in accordance with the present disclosure;

FIG. 18 is a perspective view of other apparatus in accordance with the present disclosure;

FIG. 19 is a different perspective view of the apparatus shown in FIG. 18;

FIG. 20 is a side view, corresponding to the view along line A-A shown in FIG. 17, of apparatus in accordance with the present disclosure;

FIG. 21 is a perspective view of other apparatus in accordance with the present disclosure;

FIG. 22 is a top view of the apparatus shown in FIG. 21;

FIG. 23 is a partial cross-sectional view taken along line 23-23 shown in FIG. 22; and

FIG. 24 is a perspective view of still other apparatus in accordance with the present disclosure;

FIG. 25 is a perspective view of a ballast end in accordance with the present disclosure;

FIG. 26 is a perspective view of another ballast end in accordance with the present disclosure;

FIG. 27 is a frontal view of the apparatus shown in FIG. 26;

FIG. 28 is a plan view of the apparatus shown in FIG. 26;

FIG. 29 is an exploded perspective view of the apparatus shown in FIG. 26;

FIG. 30 is a perspective view of a dummy end in accordance with the present disclosure;

FIG. 31 is a perspective view of another dummy end in accordance with the present disclosure;

FIG. 32 is a frontal view of yet another dummy end in accordance with the present disclosure;

FIG. 33 is a plan view of the apparatus shown in FIG. 32;

FIG. 34 is an exploded perspective view of the apparatus shown in FIG. 32;

FIG. 35 is a perspective view of an arrangement of a ballast end and a dummy end in accordance with the present disclosure;

FIG. 36 is a perspective view of the apparatus shown in FIG. 34;

FIG. 37 is a perspective view of another arrangement of a ballast end and a dummy end in accordance with the present disclosure;

FIG. 38 is a perspective view of yet another arrangement of a ballast end and a dummy end in accordance with the present disclosure;

FIG. 39 is a perspective view of a retrofit ballast end in accordance with the present disclosure;

FIG. 40 is a partial cross-sectional view of the apparatus shown in FIG. 39; and

FIG. 41 is a plan view of the apparatus shown in FIG. 39.

### DETAILED DESCRIPTION OF THE INVENTION

Apparatus and methods of manufacture for a ballast module for a fluorescent lamp fixture are provided. The apparatus may include a ballast housing. The apparatus may also include a lamp holder configured to be coupled to the ballast housing. A ballast may be at least partially enclosed within the ballast housing.

The lamp holder may be configured to hold one end of a tube-shaped lamp. In some embodiments of the invention, the lamp holder may be in electrical communication with a conductor such that when the lamp holder supports a lamp, the lamp holder is able to provide power from the conductor to the lamp.

When long tubes are used, two opposing lamp holders (one at each end of the lamp) are generally required—one to support and excite each end of the lamp. In embodiments in which a short or “single-ended” fluorescent lamp is used, one lamp holder for the lamp may be sufficient. It should be noted that the lamp holder may be configured to support any suitable lamp, including the T5, T8 and T12 lamps. In some embodiments, the lamp holder may be configured to support an LED lamp. In those embodiments where the lamp holder is configured to support an LED lamp, a LED driver circuit may substitute for a ballast. In some embodiments, the lamp holder may be configured to support a U-shaped lamp.

Some embodiments of the invention may include modules that may be fastened to a lamp fixture enclosure. The lamp fixture enclosure may be referred to alternately throughout the disclosure as a fixture housing. The ballast module may be fastened to the lamp fixture enclosure. A lamp holder module containing at least one lamp holder may also be fastened to the lamp fixture enclosure.

The ballast module may be arranged at one end of the lamp fixture enclosure. The lamp holder module may be arranged opposite the ballast module at the other end of the lamp fixture enclosure. In some embodiments, a second ballast module may be arranged opposite the first ballast module at the other end of the lamp fixture enclosure. Because the ballast module includes at least one lamp holder, the need for wiring between the ballast enclosed in the ballast module and the lamp holder may be reduced or eliminated. Some embodiments of the invention may include a ballast and lamp holder with a wireless connection therebetween. For example, the wiring that is present in a typical lamp fixture may be replaced by a conductor that is integrated into a structural element of the ballast. The lamp holder may be in electrical connection with the conductor integral on the ballast to create a wireless electrical connection. In other embodiments, one or more wires may be used to transmit power from the ballast to the lamp holder.

The lamp holder may be removably coupled to the ballast module and/or the lamp holder module. In some embodiments of the invention, the lamp holder may be removably coupled to the wires that transmit power from the ballast module to the lamp holder. In addition, the ballast module and/or the lamp holder module may be removable from the lamp fixture enclosure. Removable modules may facilitate repair, replacement and/or reconfiguration of the fluorescent tube pattern. In some embodiments, the repair, replacement and/or reconfiguration may take place at the point of manufacture. In other embodiments, the repair, replacement and/or reconfiguration may take place in the field.

The ballast enclosed in the ballast housing may receive power from a standard power line, such as a 110VAC power line or any other suitable power line. The ballast may include a reactive coil and a power conditioner for providing appropriate current to the lamp.

A conductor that is configured to transmit electrical power from the ballast to the lamp holder may be enclosed within the ballast housing as well. The conductor may be part of a rigid power distribution unit. In this embodiment, the conductor may be rigidly supported substantially continuously along its length.

In some embodiments of the invention, the conductor may be part of a continuous bus. The continuous bus may be configured such that one or more lamp holders may be placed at any location along the bus. A lamp holder electrical connector may mate with the continuous bus through clamping, press fit, mating, or any other suitable means. The lamp holder may be removably connected to the continuous bus.

The conductor may be included in a printed circuit board (“PCB”). The rigid power distribution unit may include the printed circuit board. The printed circuit board may have traces from each lamp holder to be plugged into it. The printed circuit board may be part of a ballast printed circuit board assembly.

The lamp holder printed circuit board may be connected to the ballast by any suitable connectors, such as male/female connectors. The ballast may be located either inside or outside a housing that may enclose the rigid power distribution unit.

The lamp holder may clamp or be otherwise mechanically and electrically secured to the printed circuit board and draw power from it. The printed circuit board may be in electrical communication with the lamp holder via flat cable and male/female connectors. In some embodiments, the lamp holder may be connected to the PCB by soldering. The lamp holder may be removably connected to the PCB via male/female connectors, pin and sleeve connectors, or any other suitable connectors. Lamp holder electrical connectors may mate with the PCB through clamping, press fit, mating, or any other suitable means.

In some embodiments, the lamp holder may be slidably connected to the PCB via a slidable contact brush, a leaf spring or any other suitable slidable contact. In these embodiments, one or more detents may be provided to position the lamp holder at one of a series of positions. The series of positions may be regular intervals. The regular intervals may be spaced apart by any suitable distance, such as 0.25 inch.

In some embodiments, the rigid power distribution unit may include a track that has conducting rails for supplying power to lamp holders. The rigid power distribution unit may include a housing. The housing may be made of plastic, metal or other suitable enclosure material.

The rails may be made of any suitable conducting metal such as copper, silver, brass or the like. For example, the conducting metal may be an abrasion-resistant metal, such as brass.

The track may be open on one or both ends for insertion of a lamp holder. An open end of the track may be blocked by a skirt after insertion of one or more lamp holders. The skirt may include any suitable material, such as a polymer or elastomer such as ethylene acrylic elastomer (“AEM”) such as that available under the trademark “VAMAC” from E. I. DuPont and Co., located in Wilmington, Delaware. The material may be an elastomer, such as neoprene. It should be noted that skirt may be removably connected to the open end of the track, allowing for the removal and/or addition of lamp holders during manufacture and/or in the field.

The rails may run along a portion of the track so that lamp holders engaging a portion of the track may receive power from the rails. The track may include a slot or edge along which the lamp holders may slide. The track may include one or more detents to maintain a lamp holder in a position along the track. In manufacturing, the track may be used to position lamp holders at any desired spacing so the track may be used in connection with fixture designs requiring different center-to-center lamp spacing. The spacing may optionally be standardized to accommodate one or more of the various industry standards.

Upon completion of the positioning of the lamp holder, the lamp holder may be permanently fixed in position after assembly. The lamp holder may be fixed in position by welding, soldering, crimping, buttressing or by any other suitable approach. Alternatively, the lamp holder may be held in place by the one or more detents or by any other suitable means. In this embodiment, the position of the lamp holder may be adjusted at a later point in time.

The aforementioned embodiments taught by the disclosure may allow for one or more lamp holders to be adjustably positioned on the ballast module. This may provide a manufacturer with the ability to use a single fixture type for more than one fluorescent tube configuration or any other desirable lamp configuration. Different configurations may be based on the different sizes and numbers of lamps such as T5, T8 and T12 style fluorescent lamps, which are commonly used in the electrical industry, in addition to any other suitable lamps.

A fixture may be fitted with one or more of several different modules having different ballasts or different lamp holder configurations.

The ballast housing may include a slotted opening that is configured to receive a portion of the lamp holder. One or more contacts or traces may be disposed inside the slotted opening to electrically communicate with the lamp holder. The contacts or traces may be in electrical communication with the ballast. The contacts or traces may be in electrical communication with the ballast via the PCB or any other suitable means. The electrical communication may involve the use of a male/female connector, a pin and sleeve connector, and/or soldering to the PCB.

The ballast housing may also include a top cover. The top cover may include one or more openings to provide various lamp holder numbers and configurations. For example, the openings may accommodate any number of lamp holders, such as 2-6 lamp holders.

The lamp holder may snap and lock into place on the top cover of the unit in such a manner as to allow for quick and easy replacement. In some embodiments, the lamp holder may be mounted on a different aspect of the ballast housing, such as a front, back or end of the ballast housing.

In some embodiments of the invention, lamp holders may be connected to the ballast housing. The lamp holders may be soldered to the ballast housing and/or form a unitary structure with the ballast housing. In some embodiments of the invention, the lamp holders may be removably coupled to the ballast housing.

The ballast housing may enclose a printed circuit board with ballast components mounted to the printed circuit board. These ballast components may extend away from the printed circuit board. The printed circuit board may be disposed on a base metal housing covered by the ballast housing. In embodiments having lamp holders that are configured to support an LED lamp, the printed circuit board may support one or more LED driver components in place of ballast components.

The ballast components may include an instant start ballast component or a rapid start ballast component or a programmed rapid start ballast component. In some embodiments of the invention, the printed circuit board may include a dimming ballast component, an emergency ballast component and/or a switching ballast component.

In some embodiments of the invention, the ballast housing may include an occupancy sensor and/or a daylight sensor or both. In embodiments that include a occupancy sensor, the ballast components may include an occupancy sensor component. In embodiments that include a motion sensor, the ballast components may include a motion sensor component.

The ballast components may be clustered together in the center of the printed circuit board, on the two ends of the printed circuit board, or at suitable intervals along the length and/or width of the printed circuit board. The ballast housing may extend above the ballast components and the printed circuit board.

The printed circuit board may be disposed on a base of the housing. The printed circuit board may have a bottom face that faces the base. The printed circuit board may have a top face that faces away from the base. The ballast components may be mounted on the top face and extend away from the housing base. The housing may have a top that is spaced apart from the printed circuit board at a distance that varies in conformance with the sizes of one or more of the components. For example, the distance may be enough to provide clearance for components where components are present on the printed circuit board. In regions of the printed circuit board where components are small or not present, the distance may be reduced.

The one or more lamp holders integrally molded into the ballast housing may be in electrical communication with one or more of the ballast components. In some embodiments, wire connectors may connect the one or more lamp holders to the one or more ballast components. In other embodiments, the lamp holders may be connected to the one or more ballast components via flat cable and male/female connectors. In other embodiments, the lamp holders may be connected to the printed circuit board through traces in the printed circuit board.

One or more line power connection leads and/or emergency ballast connection leads may exit the ballast module housing. Some or all of these leads may exit through an opening located in the front face of the mid-section of the ballast housing. Some or all of these leads may exit through an opening located at a side of the ballast housing, or in any other suitable location. The leads may be in electrical communication with a power source, such as a 120V outlet.

In embodiments of the invention that include lamp holders that are integrally molded to the ballast housing, the lamp holder module may contain a lamp holder housing with one or more lamp holders. The one or more lamp holders may be integrally molded into the lamp holder housing such that the lamp holders and a portion of the lamp holder housing form a unitary structure. In other embodiments, the lamp holders may be removably coupled to the lamp holder housing. The one or more lamp holders connected to the lamp holder housing may be in electrical communication with a conductor. The conductor may be a wire. The wire may connect to the ballast module. The wire may connect the lamp holders in series or in parallel.

The ballast module and the lamp holder module may be spaced a distance apart. The distance apart may correspond to a nominal fluorescent lamp length. This distance may enable the ballast module and the lamp holder module to support one or more fluorescent lamps therebetween. The center-to-center distance between the lamp holders included in the ballast module and the lamp holders included in the lamp holder module may be fixed.

The ballast housing and the lamp holder housing may be comprised of a thermoplastic material or any other suitable material. The ballast housing and the lamp holder housing may include one or more fastening features. The one or more fastening features may enable the ballast housing and the lamp holder housing to be fixed to a fixture housing.

The fastening feature may be a screw hole, a snap-fixture, a slot, a tab or any other suitable fastening feature. When the fastening feature is a screw hole, the screw hole may be a metal tab, captive screw and/or any other suitable holes that facilitate the attachment of the ballast housing and the lamp holder housing to a fixture housing.

The ballast module and the lamp holder module may be spaced apart so that a fluorescent lamp can be supported therebetween. The lamp holders in the ballast module and the lamp holder module may include a lamp pin guide. The lamp pin guide may alternately be referred to as a rotor. The rotor may be used to support a linear fluorescent lamp therebetween.

In embodiments that are configured to support a U-shaped lamp, the ballast module and the lamp holder module may be placed adjacent to each other. In the embodiment of the U-shaped lamp, the lamp holders contained in the ballast module and the lamp holder module may include two straight slots to support the fluorescent lamp therebetween.

In some embodiments of the invention, the ballast module and the lamp holder module may be connected by a single lead that exits at either end of the modules. In other embodiments, the ballast module and the lamp holder module may not be in direct electrical communication.

In some embodiments of the invention, the ballast module may be configured to replace a previously installed ballast module. The previously installed ballast module may be removed, and the ballast module subsequently fixed to the fixture enclosing. In these embodiments, the ballast module and the lamp holder module may alternately be referred to as a retrofit ballast module and a retrofit lamp holder module.

The retrofit ballast module may produce more light using less energy than the previously installed ballast module. In these embodiments, the retrofit ballast module and the retrofit lamp holder module may be configured to support a lamp such as the T5 lamp, whereas the previously installed ballast module and lamp holder module were configured to support at T8 lamp.

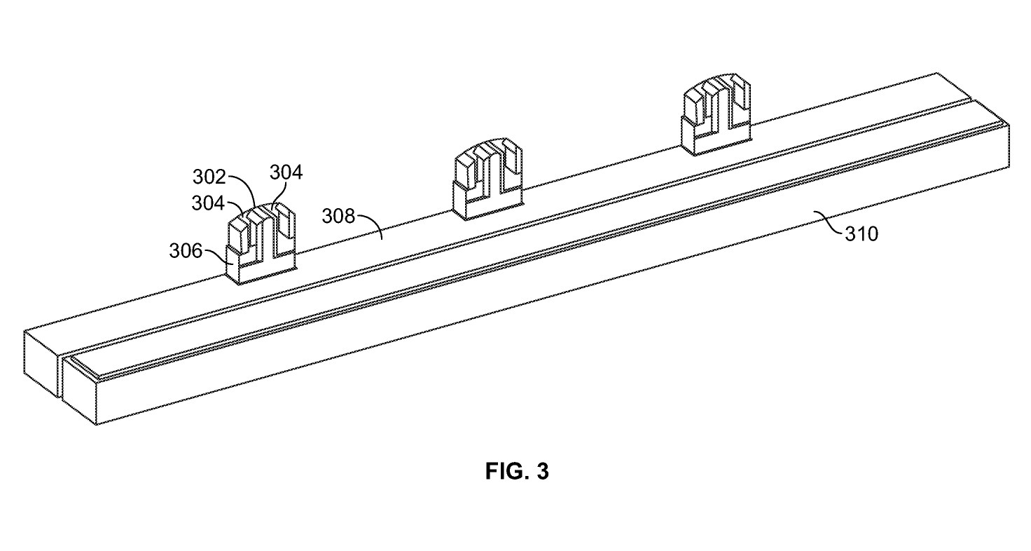

FIGS. 3-41 show illustrative embodiments and features of the invention.

FIG. 3 shows illustrative body 308. Three lamp holders 302 are attached to body 308. Body 308 may be a ballast module. Body 308 may be a unitary structure and may be made of a non-conductive material. Alternatively, body 308 made be made from an assembly of parts. In the present embodiment, body 308 is assembled onto a PCB and includes apertures configured to receive and support lamp holders 302. Enclosure 310 encloses the PCB which may be constructed of sheet metal. Body 308 is dimensioned such that, when assembled, the lamp holders 302 are supported and enclosed with no access to live parts.

Lamp holders 302 may include one or more electrical contacts configured to conduct electricity from lamp holder 302 to one or more lamps installed in lamp holder 302. Each lamp holder may include slots 304 which allow for pins of fluorescent lamps to engage with the electrical contacts. It should be noted that the systems and methods of the invention include lamp holders of any suitable configuration (including, for example, the rotary lamp holders shown in FIG. 9).

Body 308 may at least partially contain a conductive bus, a ballast, wiring, or any combination of one or more of these elements. Lamp holders 302 may be removable from body 308 for replacement, repair, or reconfiguration during manufacture and/or in the field.

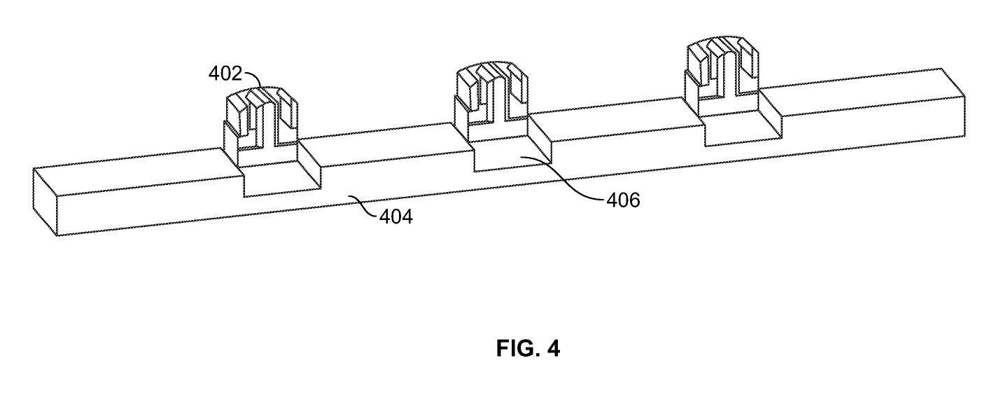

FIG. 4 shows illustrative body 404. Body 404 may include one or more depressions 406. Depressions 406 may be adjacent to one or more lamp holders 402. Depressions 406 may allow for shorter lamp holders 402 to be inserted into body 404 resulting in a thinner overall profile of the fixture. This is advantageous in certain installations when space is limited.

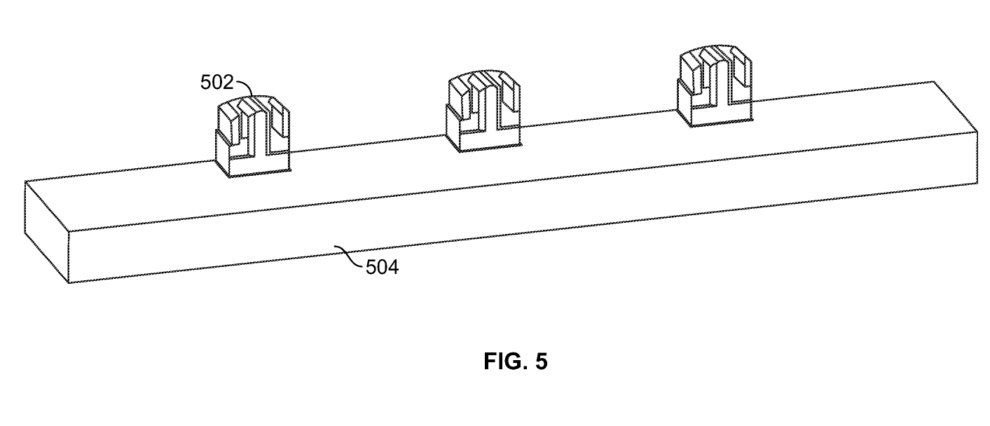

FIG. 5 shows illustrative body 504. Lamp holders 502 are attached to body 504, wherein the attachment provides an electrical connection therebetween.

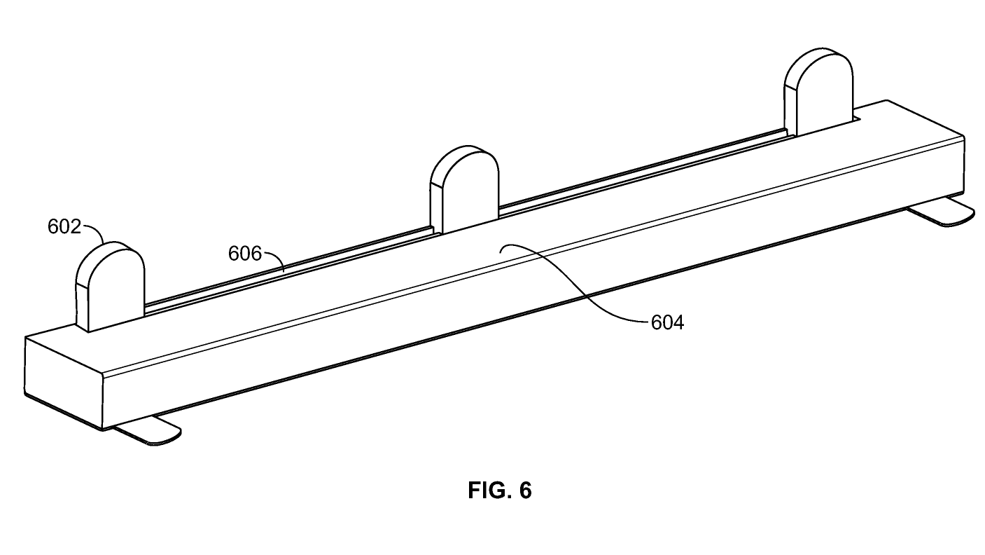

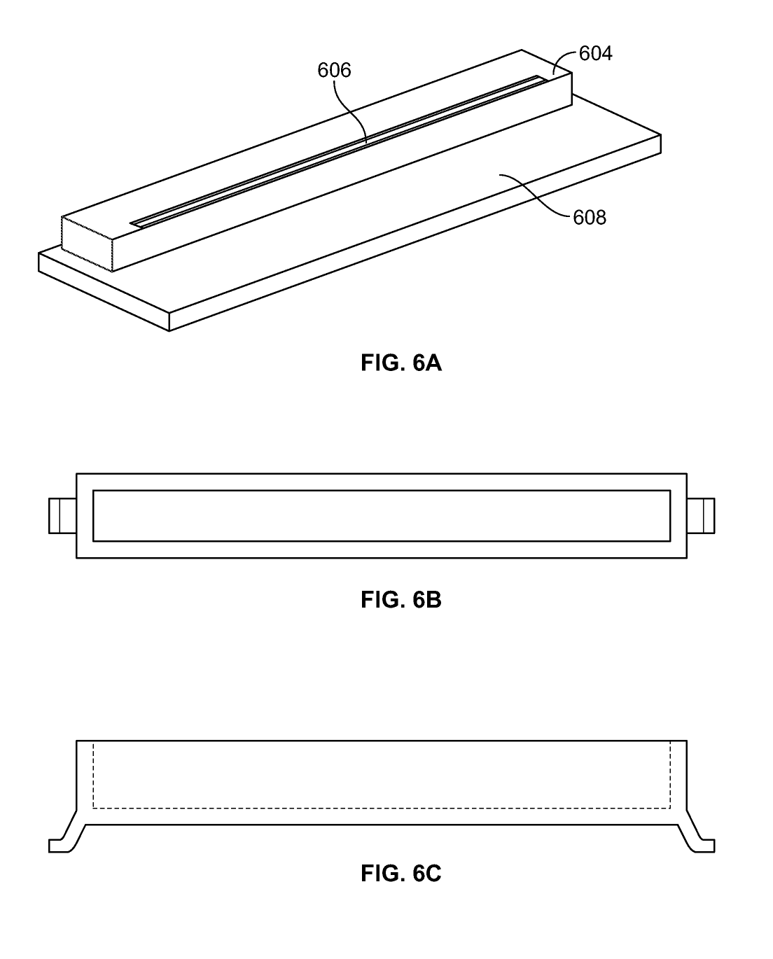

FIG. 6 shows illustrative body 604. Slot 606 in body 604 allows for one or more lamp holders 602 to be installed in body 604 at any point along slot 606. An electrical bus may run along the length of body 604, allowing the lamp holders to be placed at any point along slot 606.

In some embodiments of the invention, slot 606 may include fixed points (not shown) in which lamp holders 602 may be installed. The fixed points may be located at any suitable interval along slot 606, such as 0.25 inch along the length of slot 606.

FIG. 6A shows that PCB 608 may be located below body 604. The bus may take the form of a trace along PCB 608. Contact points may be located below slot 606 to connect to lamp holders 602. In addition, optional detents may be included in the housing, on the PCB, or on any other suitable member in order to positively locate the lamp holders at regular intervals along the bus.

FIG. 6B shows a top view of body 604 without lamp holders 602 and with the cover of body 604 removed. FIG. 6C shows a side view of body 604 without lamp holders 602 and with the cover of body 604 removed.

FIG. 7 shows illustrative body 704. Each lamp holder 702 includes a leg 708 which is disposed perpendicularly to the main lamp holder body 710. In this embodiment, the lamp holder exits along side face 706 of the body instead of along top face 704.

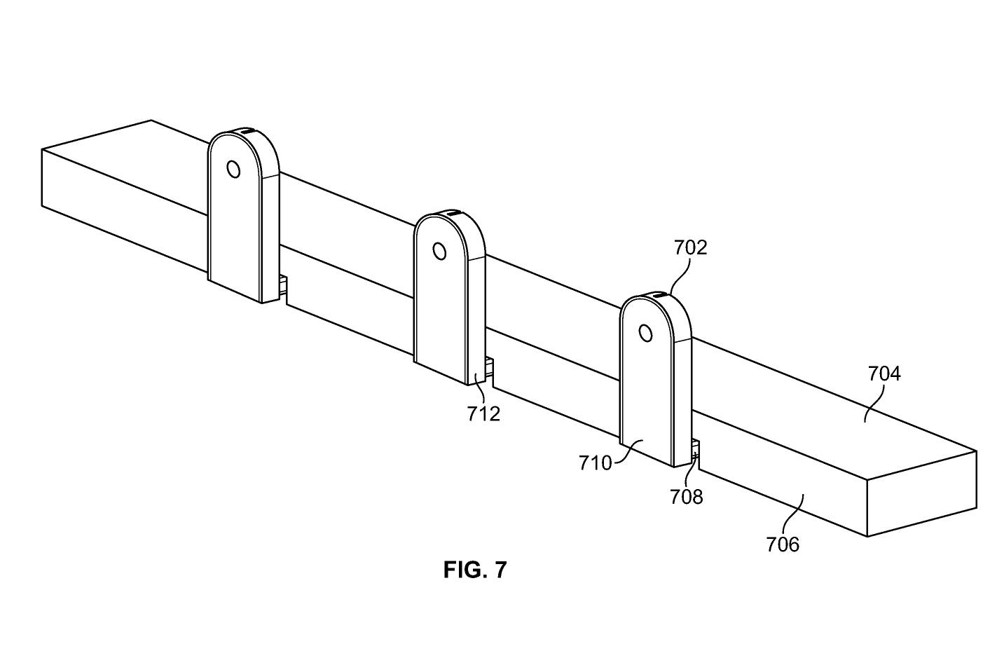

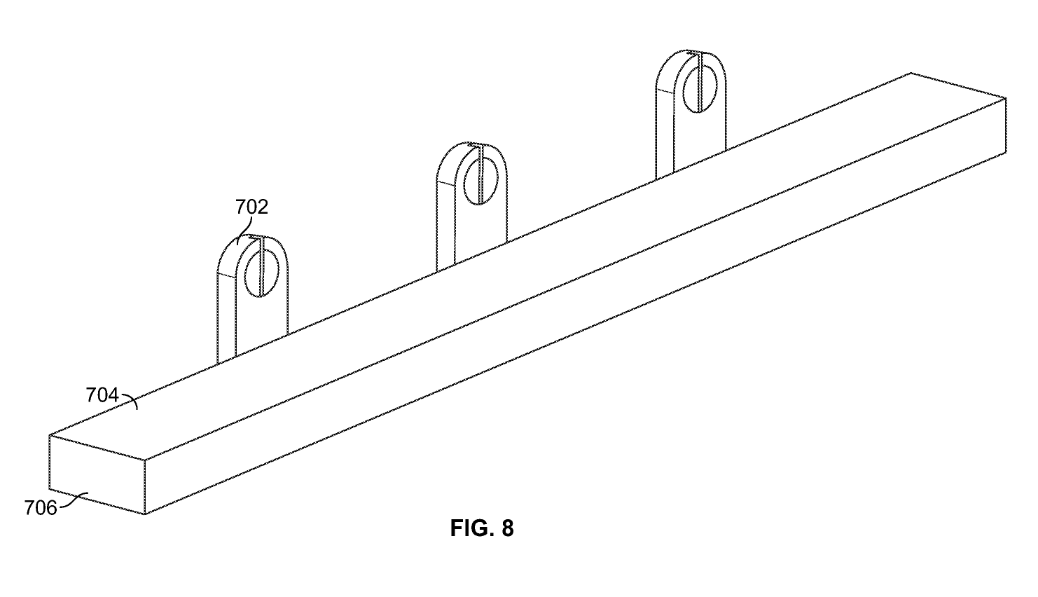

FIG. 8 shows a perspective view of body 704.

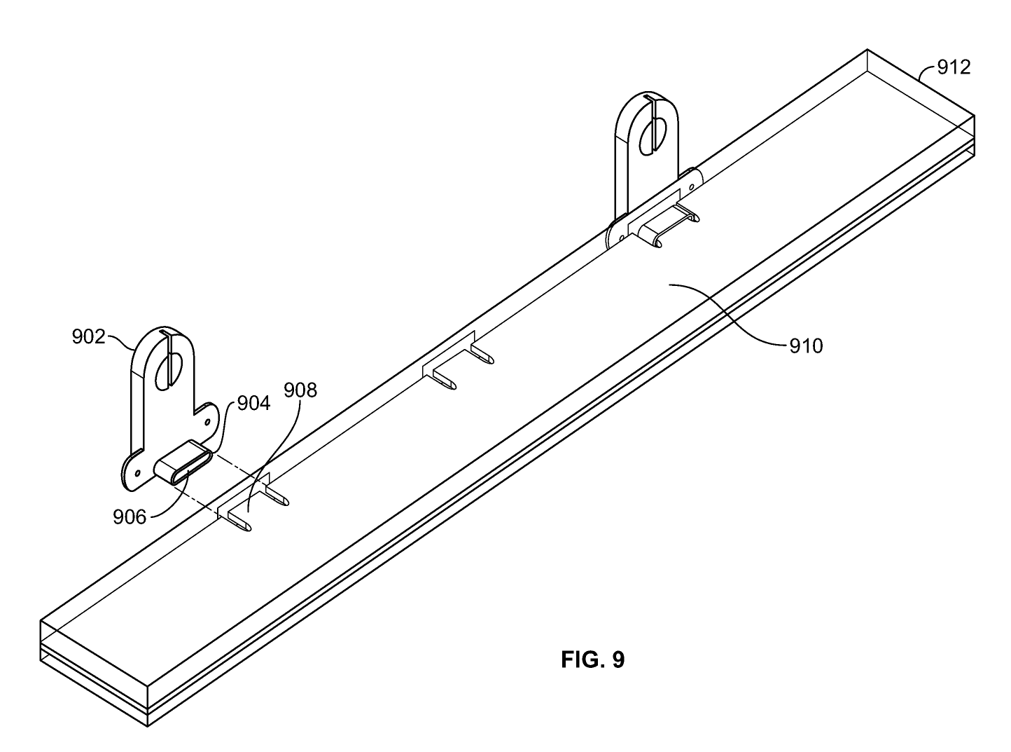

FIGS. 9 and 10 show illustrative PCB 910 with a portion of housing 912 removed to show internal components. PCB 910 is at least partially enclosed within housing 912. PCB 910 may support a ballast. PCB 910 may include one or more PCB tabs 908 which are disposed to engage opening 906 of leg 904 of lamp holder 902. A contact may be located on PCB tab 908. The contact may be a trace on PCB 910. The contact may provide power to lamp holder 902.

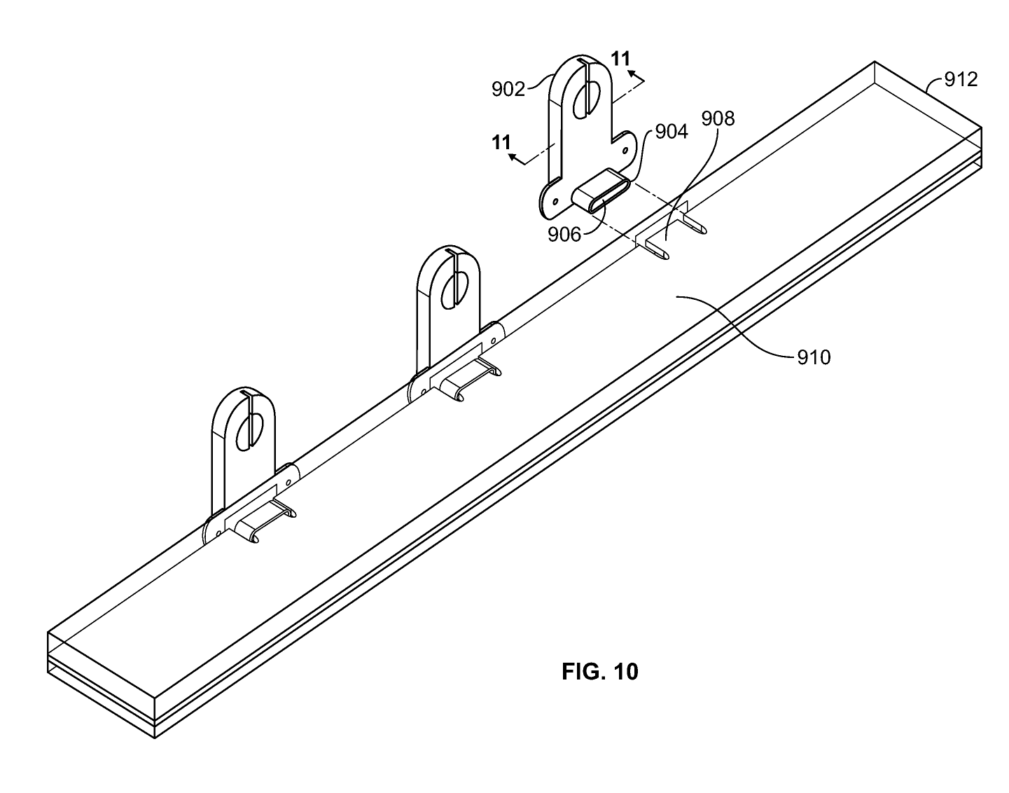

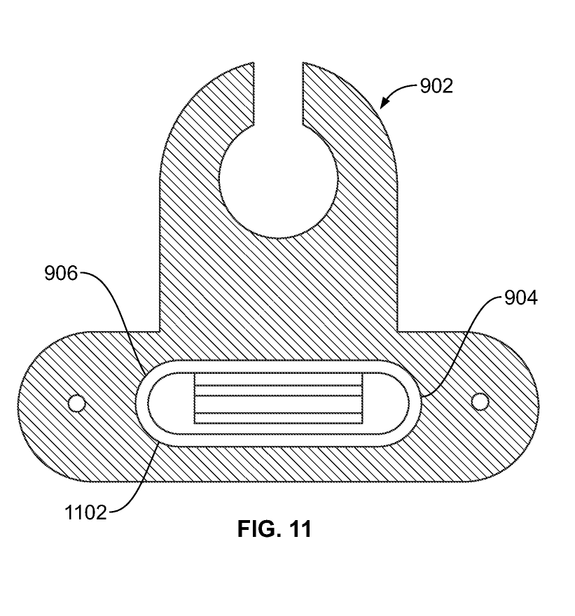

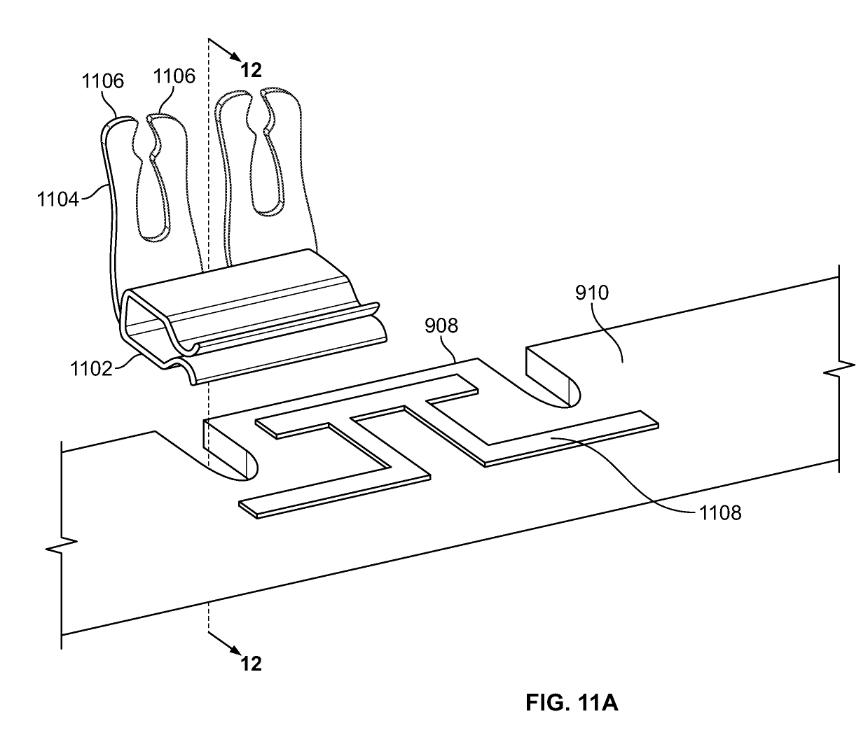

FIG. 11 illustrates a partial cross sectional view along line 11-11 shown in FIG. 10 of illustrative lamp holder 902 with leg 904 and opening 906. FIG. 11 further illustrates sleeve 1102 that is configured to make electrical contact with a PCB, as further illustrated in FIG. 11A.

FIG. 11A illustrates a detailed view of a contact 1104 that is contained in illustrative lamp holder 902. Contact 1104 may include one or more tines 1106 that are disposed to connect to pins of a lamp. Contact 1104 may additionally include sleeve 1102. Sleeve 1102 may be disposed to slide over PCB tab 908 and make electrical contact with conductor 1108. Conductor 1108 may be a trace on PCB 910.

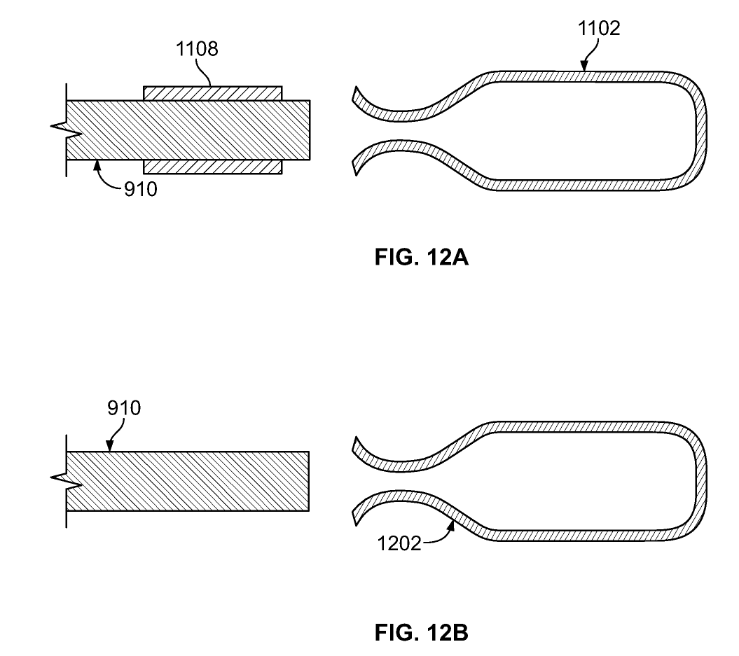

FIGS. 12A and 12B show sections taken along line 12-12 shown in FIG. 11A. FIG. 12A illustrates a cross sectional view of sleeve 1102 and a cross sectional view of conductor 1108 disposed along the top and bottom surfaces of PCB 910. FIG. 12B illustrates an alternate contact geometry of the contact geometry illustrated in FIG. 12A that is included in some embodiments of the invention.

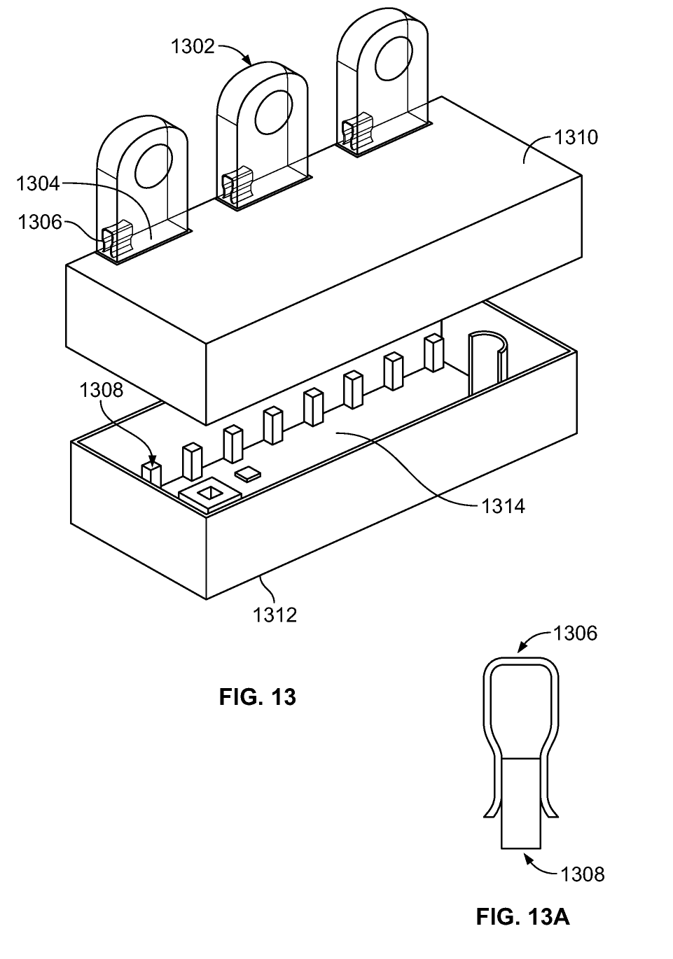

FIG. 13 shows illustrative body 1310. Lamp holder 1302 may be removably attached to body 1310. Lamp holder 1302 may be easily assembled and removed from body 1310 for replacement, repair and/or reconfiguration. In some embodiments of the invention, lamp holder 1302 may be a lamp holder that has a locking feature (not shown). The locking feature of lamp holder 1302 may be a snap hook arm. The locking feature, when depressed, may unhook the lamp holder from body 1310 without the need of a special tool.

Body 1310 may include apertures 1304 to receive one or more lamp holders 1302. PCB 1314 may be at least partially disposed within body 1310. In some embodiments of the invention, a ballast and/or additional electrical components may be disposed in body 1310 as well. PCB 1314 may include pin 1308. Pin 1308 may engage sleeve 1306 of lamp holder 1302. The engagement of pin 1308 with sleeve 1306 may provide power from PCB 1314 to lamp holder 1302. Pins 1308 may be spaced at regular intervals such as 0.25 inches and may have a cross-section of any suitable shape and size such as 0.062 inch round pins. Sleeves 1306 may be of any suitable shape and size such as having a gap in the sleeve of 0.030 inches. In addition, the PCB may be of any suitable shape or size such as having a thickness of 0.062 inches.

While the pins and sleeves shown in FIG. 13 provide power from PCB 1314 to lamp holders 1302, any suitable mating electrical connectors may be used. In some embodiments of the invention, lamp holders 1302 may include pins and the PCB may include sleeves, wherein the mating of the pins to the sleeves provides electrical power from PCB 1314 to lamp holder 1302.

FIG. 13A shows a cross sectional view of sleeve 1306 of illustrative lamp holder 1302 when mated to pin 1308 of PCB 1314. The mating of sleeve 1306 to pin 1308 may create an electrical connection therebetween.

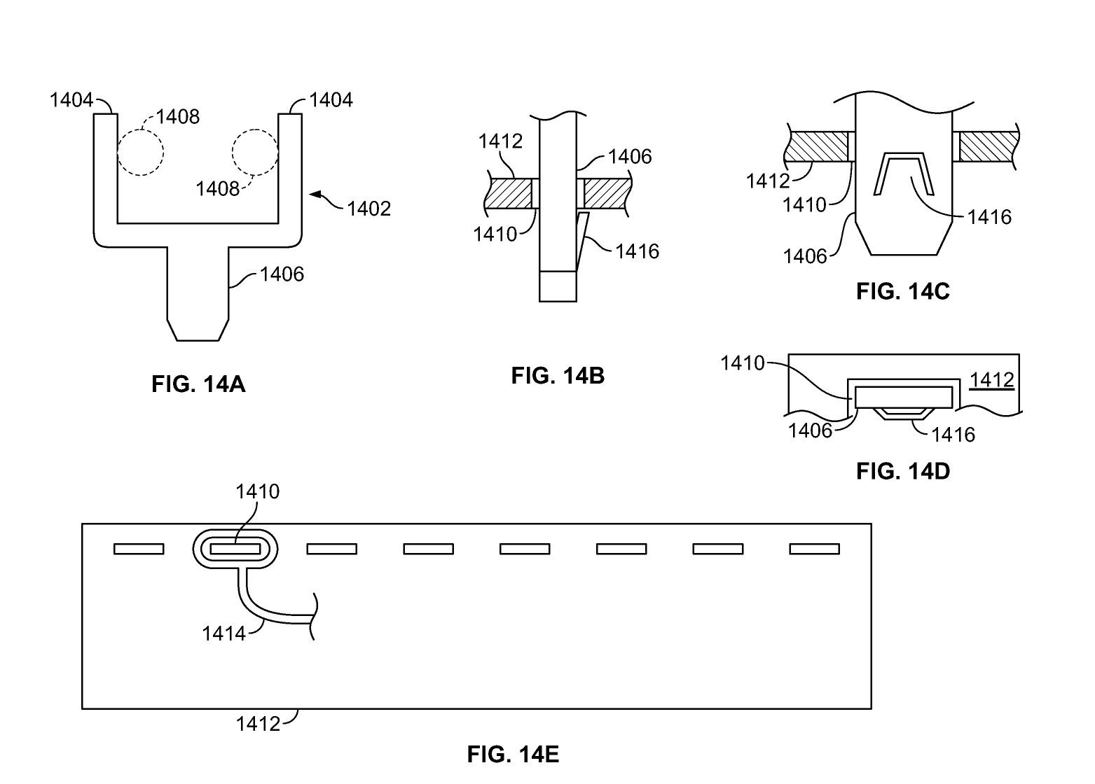

FIGS. 14A-14D show illustrative tang 1406 that may be located on contact 1402 of a lamp holder taught by the invention. Contact 1402 may contain one or more tines 1404 configured to contact pins 1408 of a lamp. Contact 1402 may additionally contain conductive tang 1406.

FIG. 14E shows illustrative PCB 1412. Conductive tang 1406 may be configured to connect to PCB 1412. PCB 1412 may have one or more openings 1410 configured to receive tang 1406. Tang 1406 may include tab 1416. Tab 1416 may be configured such that, when tang 1406 is inserted into opening 1410, tang 1406 latches in place. Tang 1406 may then be electrically connected to PCB 1412. In some embodiments of the invention, Tang 1406 may be soldered to trace 1414 of PCB 1412.

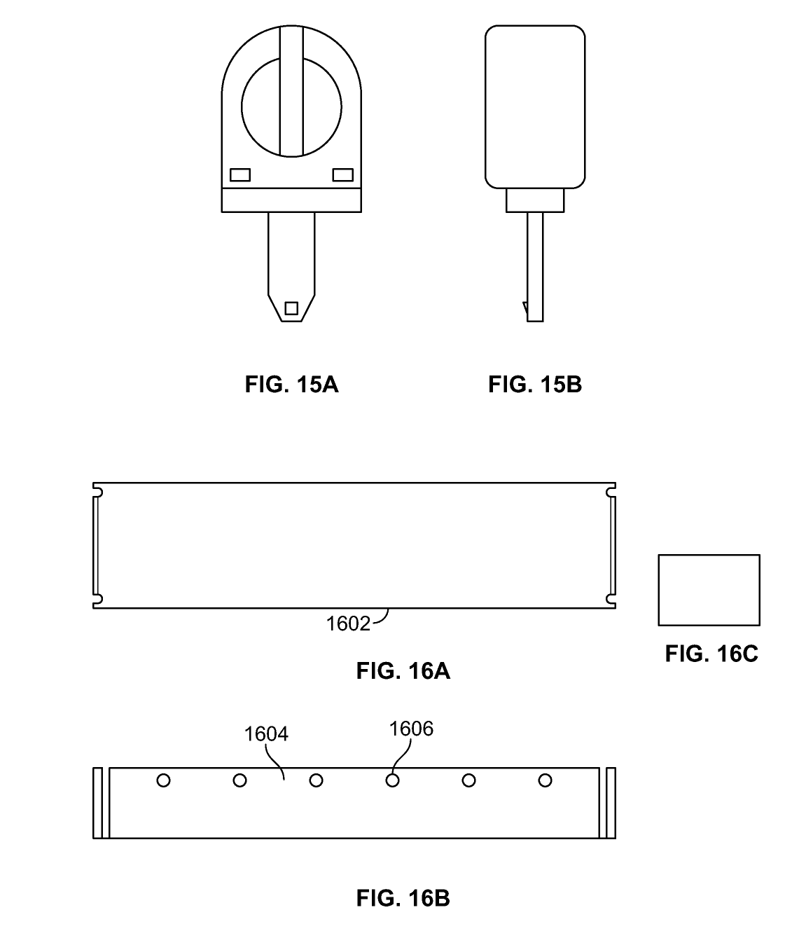

FIGS. 15A and 15B show an illustrative rotary lamp holder with its associated contact and tang that may be used in some embodiments of the invention. FIG. 15A illustrates a frontal elevational view of the rotary lamp holder. FIG. 15B illustrates a side view of the rotary lamp holder. The rotary lamp holder illustrated in FIG. 15 may be used to snap onto a PCB such as PCB 1412 illustrated in FIG. 14.

FIG. 16A shows illustrative cover 1602 which may be used to encase any of the apparatus taught by the systems and methods of the invention. FIG. 16B shows illustrative wall 1604 of cover 1602. Wall 1604 may include latching tabs 1606 which are disposed to secure the cover 1602 to other parts of the device housing. Tabs 1606 may be in the form of barbs. FIG. 16C illustrates a side view of the housing illustrated in FIGS. 16A and 16B.

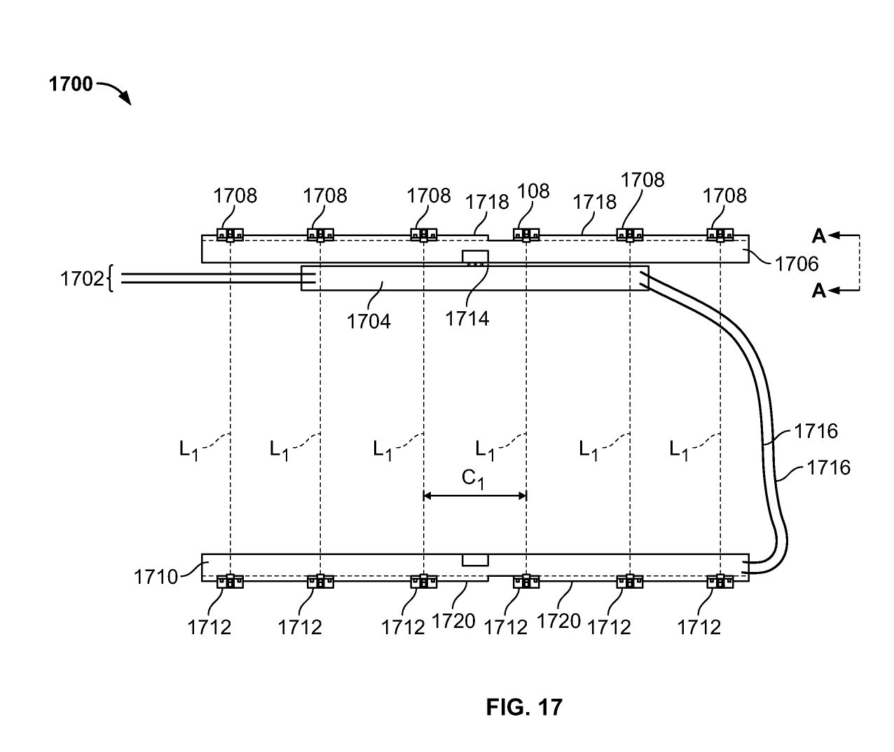

FIG. 17 shows schematically lamp support 1700. Lamp support 1700 includes power input leads 1702, ballast 1704, rigid power distribution unit 1706 and lamp holders 1708. Lamp support 1700 also includes rigid power distribution unit 1710 and lamp holders 1712. Each of lamp holders 1708 has a facing lamp holder 1712. Together, a pair of lamp holders—one 1708 and a corresponding 1712—hold a fluorescent lamp or tube at its ends. Lines L1 represent the center lines of lamps that may be installed between corresponding lamp holders. Adjacent lines L1 may be separated, for example, by center-to-center distance C1.

Rigid power distribution units 1706 and 1710 may be affixed to an enclosure (not shown). Ballast 1704 receive power via leads 1702 and provide the power to lamp holders 1708 via rigid power distribution unit 1706. Rigid power distribution unit 1706 may be connected to ballast 1704 by connector 1714. Connector 1714 may be a pin connector or any other suitable connector. Rigid power distribution unit 1710 may receive power from ballast 1704 via leads 1716.

One or both of rigid power distribution units 1706 and 1710 may include a printed circuit board for delivering power along traces or conductors to lamp holders 1708 and 1712, respectively. Positive and negative conductors, each corresponding to one of leads 1702 and one of leads 1716, may be provided along edges 1718 and 1720, respectively, of rigid power distribution units 1706 and 1710. The positive and negative conductors may match corresponding positive and negative terminals of lamp holders 1708 and 1712. The positive and negative conductors may be arranged in any suitable configuration. For example, in some embodiments, the positive and negative conductors may be, respectively, on top and bottom of edges 1718 and 1720. In some embodiments, both the positive and negative conductors both may on one side (top or bottom) of edges 1718 and 1720. The positive and negative conductors may be routed through their respective rigid power distribution units in any suitable manner to deliver power to positions on edges 1718 and 1720 where power is or may be desired. In some embodiments, power may be routed to points on edges 1718 and 1720. In some embodiments, power may be routed to elongated segments of edges 1718 and 1720. The segments may allow lamp holders 1708 and 1712 to be positioned with greater flexibility.

In some embodiments the segments may be sufficiently elongated that the lamp holder may be attached subject to an appropriate mechanical tolerance, but sufficiently restricted such that a properly installed lamp holder will shield the segment from contact with other objects. In some embodiments, the traces may be below the surface of the rigid power distribution unit. In those embodiments, the lamp holders may be provided with crimps or fasteners to make electrical contact with the traces. Rigid power distribution units 1706 and 1710 should be sufficiently rigid to mechanically support lamp holders 1708 and 1712 such that corresponding lamp holders can support and power a lamp.

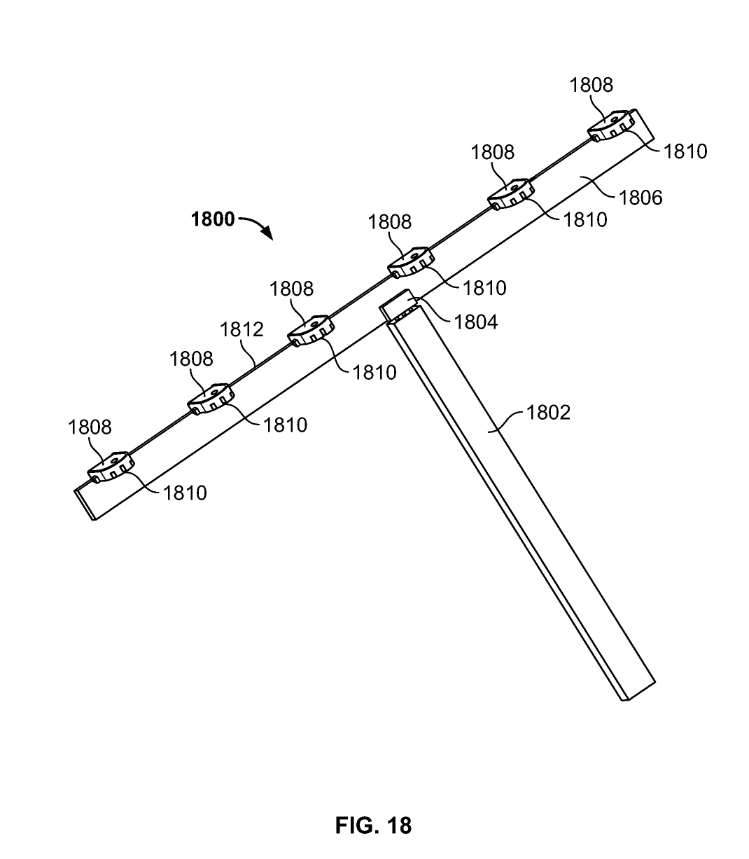

FIG. 18 shows in perspective, from below (in an operational orientation), illustrative lamp support 1800. Lamp support 1800 includes ballast 1802. Ballast 1802 connects via connector 1804 to rigid power distribution unit 1806. Rigid power distribution unit 1806 may mechanically support lamp holders 1808 via a press fit of lamp holders 1808 onto edge 1812. Edge 1812 includes conductors to provide power to electrical terminals (not shown) of lamp holders 1808. Rigid power distribution unit 1806 may be a printed circuit board that has traces that deliver power to lamp holders 1808. Lamp holders 1808 may include pin slots 1810 for receiving pins of fluorescent lamps.

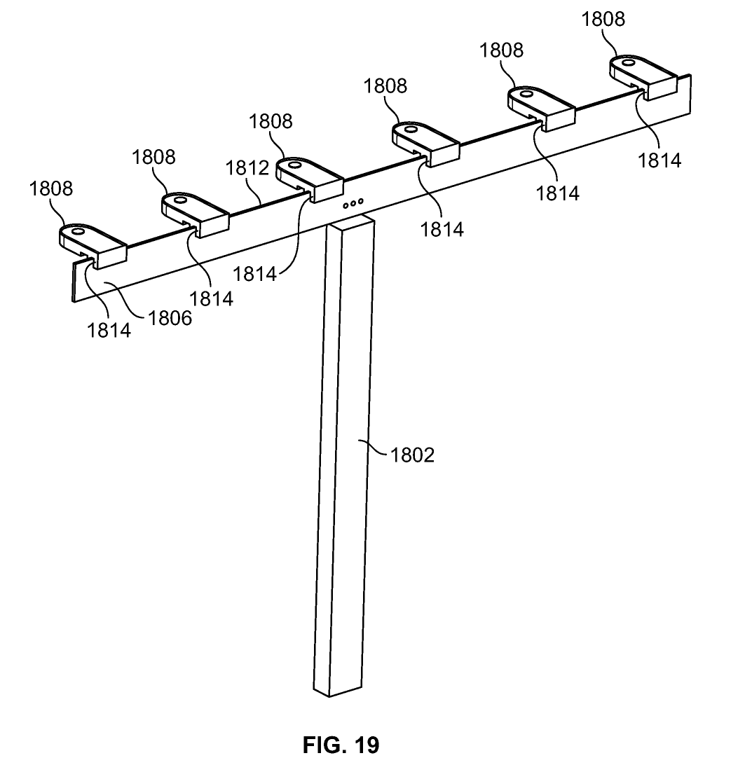

FIG. 19 shows lamp support 1800, in perspective, from above (in an operational orientation). Slots 1814 in lamp holders 1808 may be press fit onto edge 1812. Slots 1814 may include electrical terminals for transmitting power from edge 1812 to lamps, when lamps are installed in lamp holders 1808.

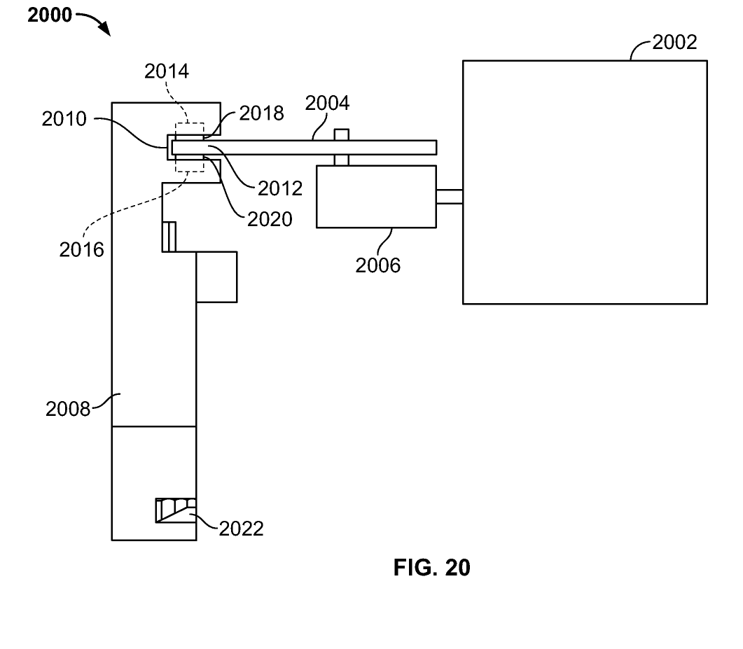

FIG. 20 shows illustrative lamp support 2000 in side view. The view shown in FIG. 20 may correspond to a side view along direction A-A, shown in FIG. 17. Lamp support 2000 includes ballast 2002. Lamp support 2000 include rigid power distribution unit 2004. Ballast 2002 and rigid power distribution unit 2004 may be electrically joined by connector 2006. Lamp holder 2008 may have groove 2010 for mating with edge 2012 of rigid power distribution unit 2004. Groove 2010 may include terminals 2014 and 2016 for contacting traces 2018 and 2020, respectively, on edge 2012. Slot 2022 may be provided for testing circuit continuity via lamp holder 2008.

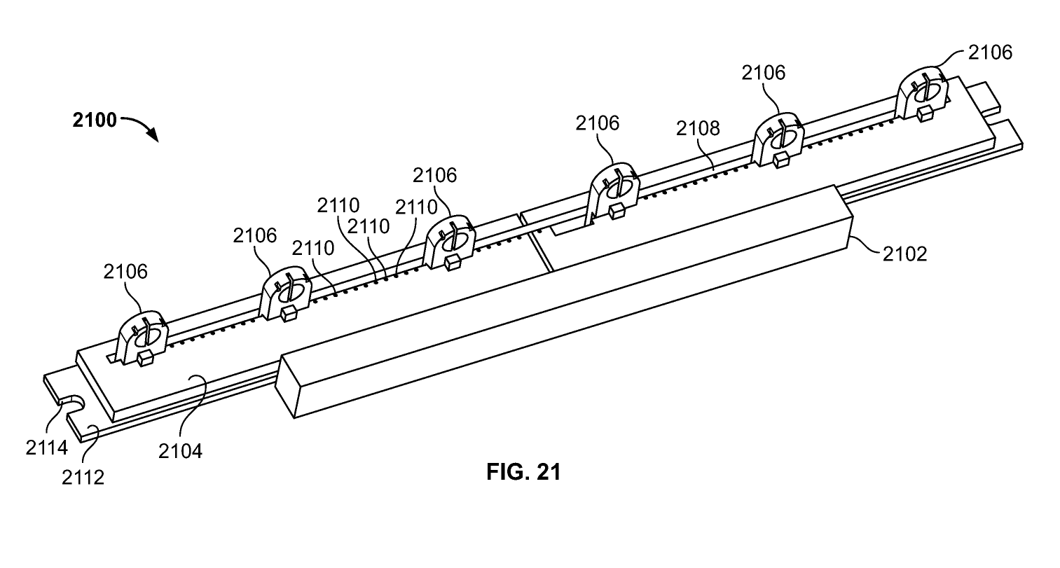

FIG. 21 shows illustrative lamp support 2100. Illustrative lamp support 2100 includes ballast 2102 and rigid power distribution unit 2104. Lamp holders 2106 are slidably mounted in track 2108 of rigid power distribution 2104. Detents, such as detents 2110, or any other suitable detents, may be present in or about track 2108 to provide determined locations at which lamp holders 2106 may be maintained. Ballast 2102 may receive power via leads (not shown). Ballast 2102 may provide power to rigid power distribution unit 2104 via a connector (not shown). Ballast 2102 may provide power to a distal power distribution unit (not shown) via leads (not shown). The distal power distribution unit may support a distal end of one or more lamps. (Rigid power distribution unit 2104 may be referred to as a “proximal” power distribution unit, because it is adjacent ballast 2102).

Rigid power distribution unit 2104 may be mounted to plate 2112. Plate 2112 may have any suitable features for attaching lamp support 2100 to a lamp enclosure (not shown) or any other suitable structure.

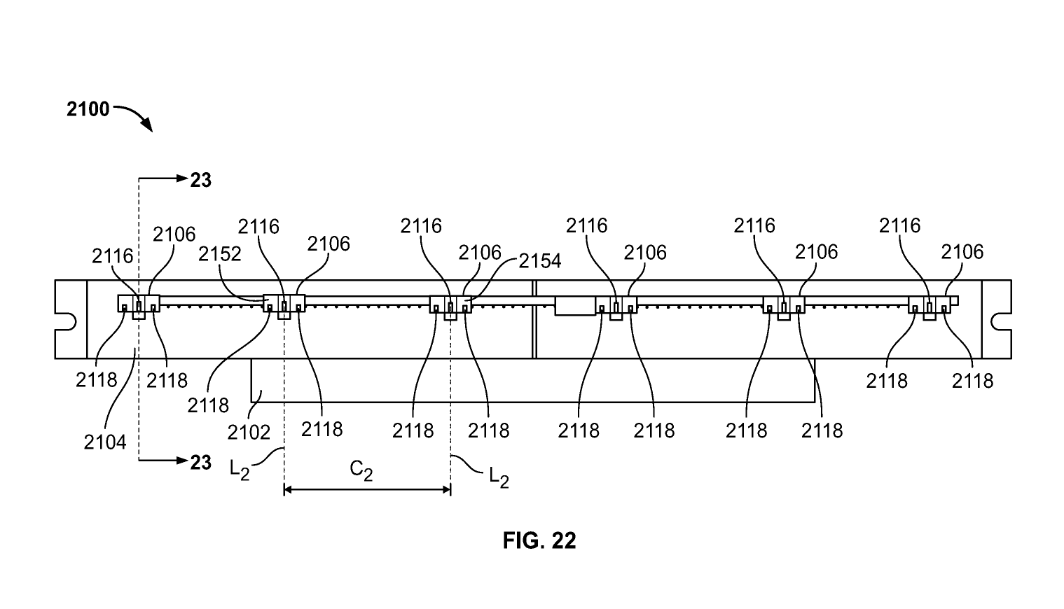

FIG. 22 shows a perspective view of lamp support 2100. Lamp holders 2106 may include slots 2116 for receiving terminal pins from a lamp. (It will be appreciated that there are different arrangements by which lamp holders may mechanically and electrically engage lamps. Any suitable lamp holder may be used in conjunction with the lamp supports shown and described herein). Test holes 2118 may optionally be present in lamp holders 2106 to receive continuity test probes.

FIG. 22 also shows lamp center lines L2, which correspond to lamps that may be installed in lamp support 2100. Distance C2 between adjacent lines L2 may be adjusted by sliding lamp holders 2152 and 2154. By adjusting C2 during a manufacturing or assembly process, lamp support 2100 may be used for different luminaires having different center-to-center lamp distances.

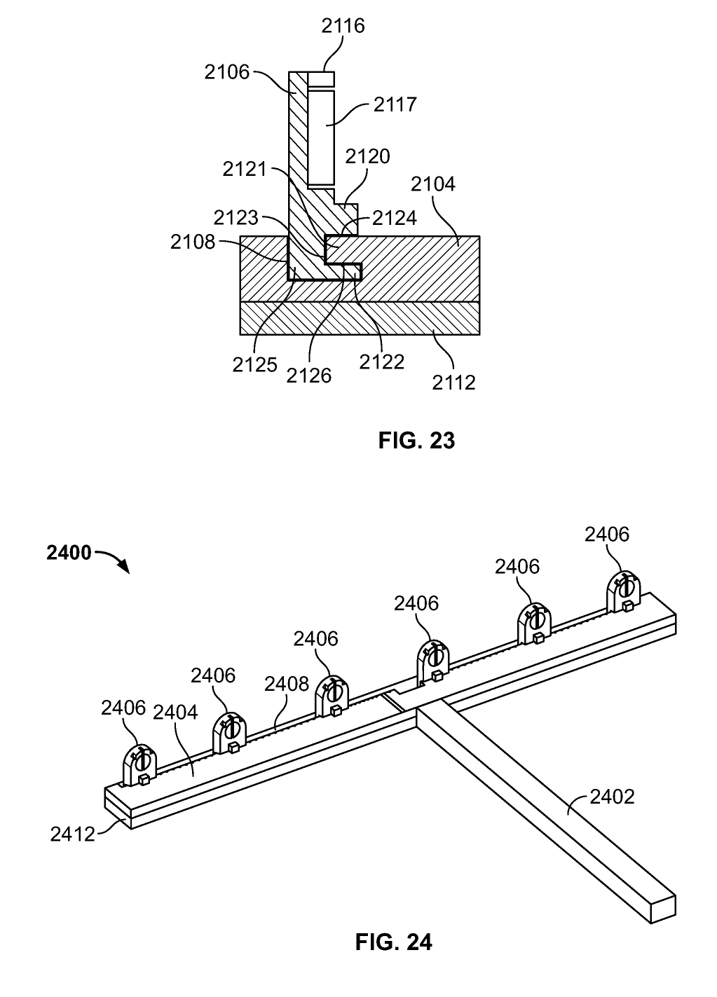

FIG. 23 shows additional detail of the lamp holders 2106 and their mechanical and electrical interface with rigid power distribution unit 2104. Slots 2116 may open up to a cavity (not shown) for receiving the end of a lamp. Contact pin guide 2117 may guide pins at the end of the lamp during installation of the lamp in lamp holder 2106. Lamp holder 2106 may include groove 2123, which may be defined at least in part by bosses 2120 and 2122. Groove 2123 may receive tongue 2121 of rigid power distribution unit 2104. Knee 2125 at the base of lamp holder 2106 may occupy groove 2108. Any suitable adjacent surfaces between lamp holder 2106 and rigid power distribution unit 2104 may be used for transferring electrical power between the two. For example, interfacial surfaces 2124 and 2126 may include electrical contacts for transferring the power. In general, positive and negative contact will be present on lamp holder 2106 and rigid power distribution unit 2104. In some embodiments, the positive and negative contacts may be in opposite sides of a structure, such as tongue 2121. In some embodiments, the positive and negative contacts may be separated from each other, but on the same interfacial surface.

FIG. 24 shows illustrative lamp support 2400. Lamp support 2400 includes ballast 2402 in a perpendicular orientation with respect to rigid power distribution unit 2404 and plate 2412. Lamp holders 2406 are slidably mounted in track 2408. It will be appreciated that the ballasts shown and described herein may be mounted in any suitable orientation with respect to a corresponding rigid power distribution unit.

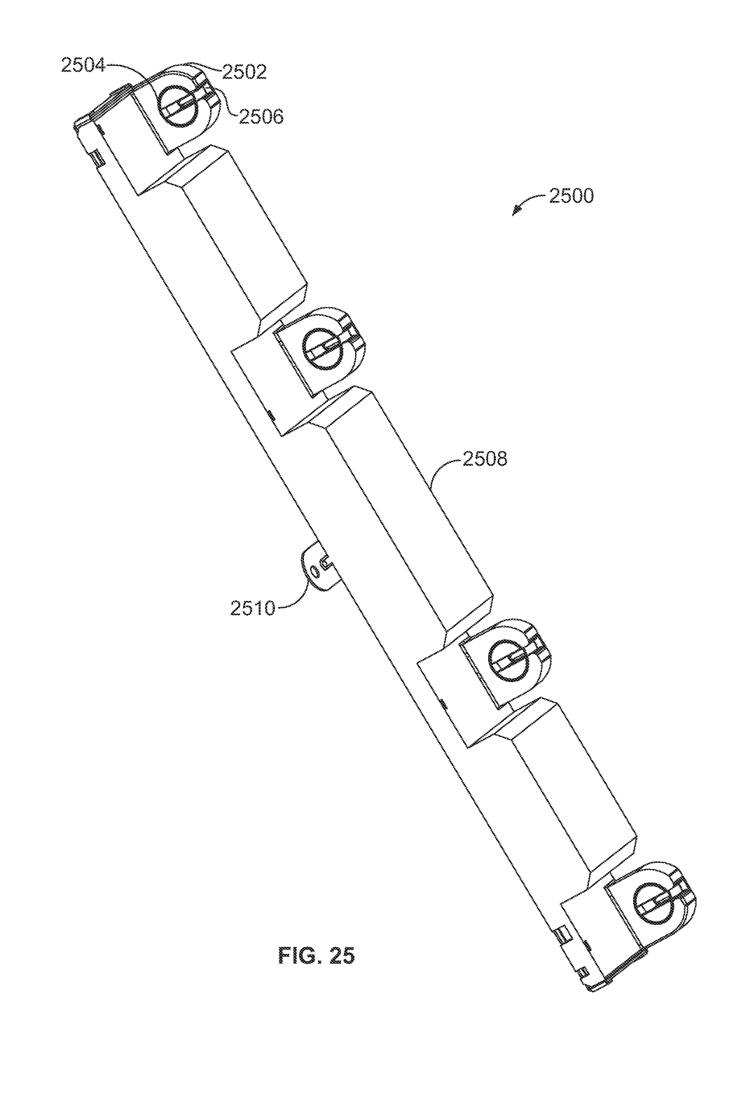

FIG. 25 shows illustrative ballast module 2500. Illustrative ballast module 2500 may include lamp holders 2502. Lamp holders 2502 may have one or more of the features shown or described herein in connection with lamp holder 200. Lamp holders 2502 may include lamp pin guide 2504. Lamp pin guide 2504 may alternatively be referred to as a rotor. Lamp pin guide 2504 may be configured to facilitate the rotation of paired contact pins from a fluorescent lamp. Lamp holders 2502 may additionally include pin slot 2506. Pin slot 2506 may be configured to receive paired contact pins from a fluorescent lamp.

Illustrative ballast module 2500 may include ballast cover 2508. Ballast cover 2508 may at least partially enclose the circuitry of a T5, T8 or T12 ballast. Illustrative ballast module 2500 may include fastening feature 2510. Fastening feature 2510 may be used to attach ballast module 2500 to a fixture housing.

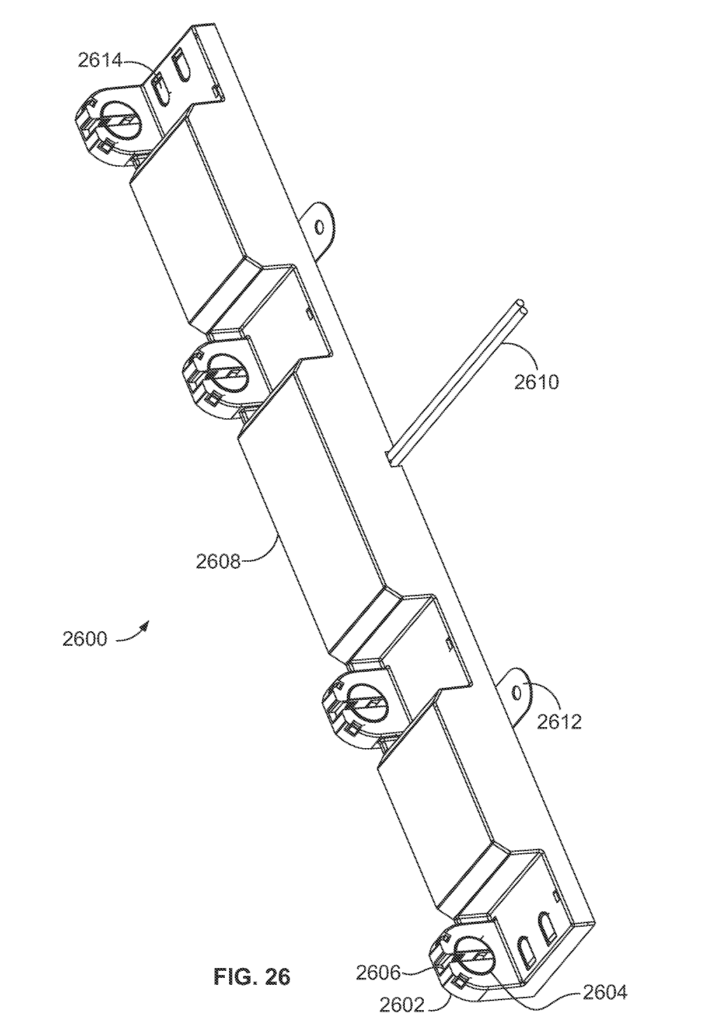

FIG. 26 shows illustrative ballast module 2600. Illustrative ballast module 2600 may include lamp holders 2602, lamp pin guide 2604, pin slot 2606, ballast cover 2608 and fastening feature 2612. Illustrative ballast module 2600 may include conductors 2610. Conductors 2610 may be wires. Conductors 2610 may draw power from a 120-V power source or any other suitable power source. The power drawn by conductors 2610 may be used to power ballast circuitry enclosed in ballast cover 2608. Illustrative ballast module 2600 may also include socket 2614.

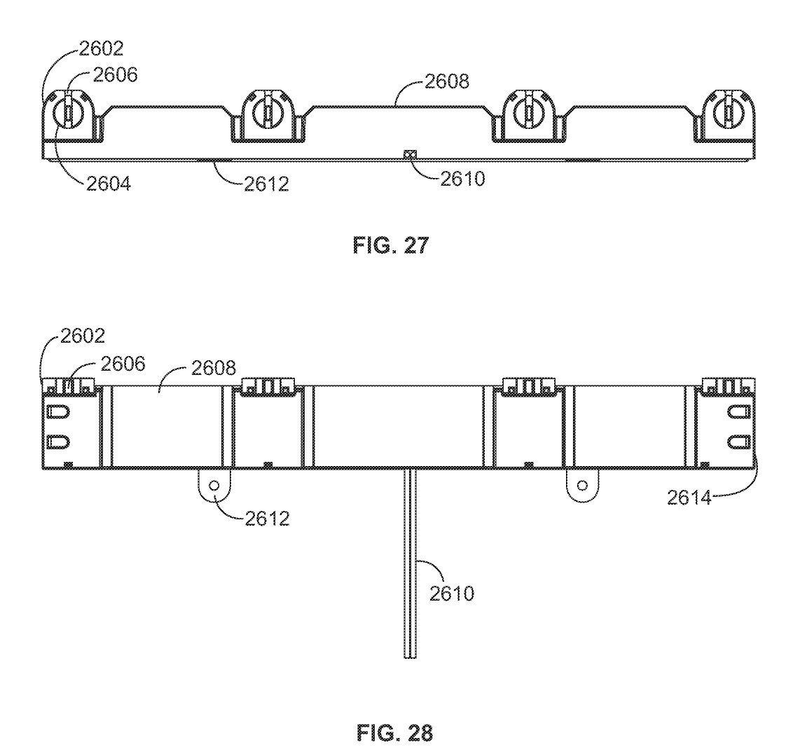

FIG. 27 shows a frontal view of ballast module 2600.

FIG. 28 shows a plan view of ballast module 2600.

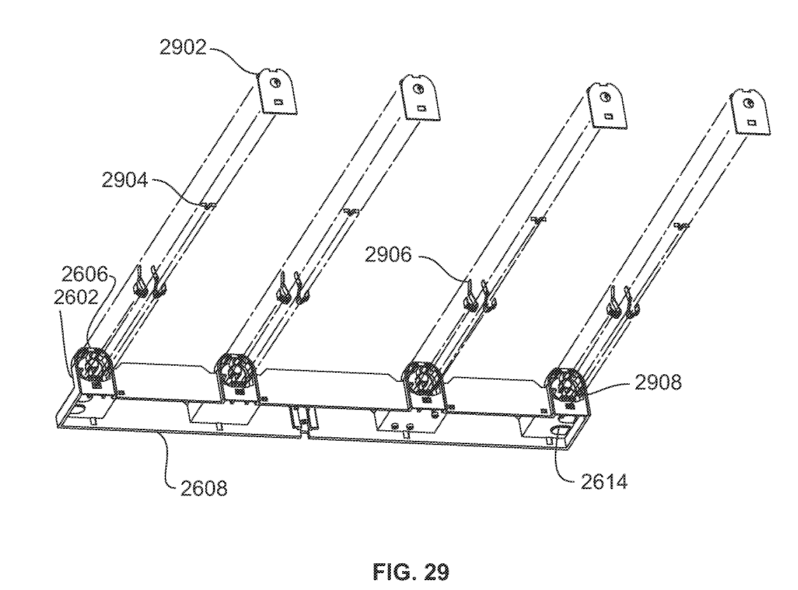

FIG. 29 shows a partially exploded perspective view of ballast module 2600. Ballast module 2600 may include cover 2902. Cover 2902 may be used to cover components present in lamp holders 2602. Ballast module 2600 may additionally include shunt contact 2904, pin contact 2906, and rotor 2908. These components may enable a fluorescent lamp to be supported and/or powered by lamp holders 2602.

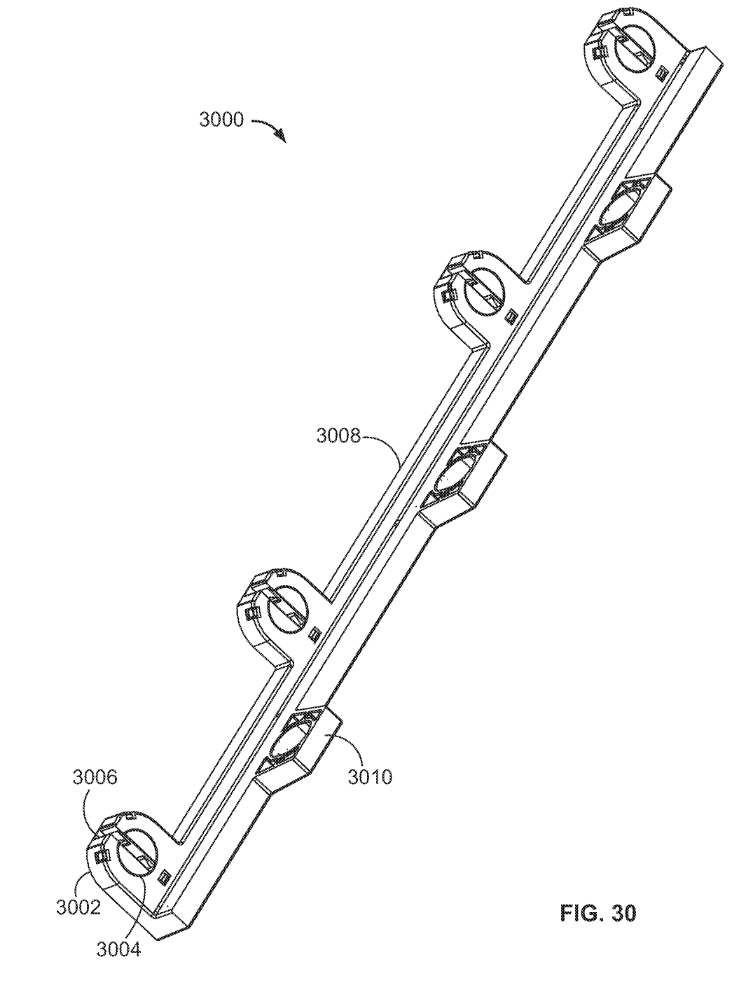

FIG. 30 shows illustrative lamp holder module 3000. Lamp holder module 3000 may include lamp holders 3002. Lamp holders 3002 may have one or more of the features shown or described herein in connection with lamp holder 200. Lamp holders 3002 may include lamp pin guide 3004. Lamp pin guide 3004 may alternatively be referred to as a rotor. Lamp pin guide 3004 may be configured to facilitate the rotation of paired contact pins from a fluorescent lamp. Lamp holders 3002 may additionally include pin slot 3006. Pin slot 3006 may be configured to receive paired contact pins from a fluorescent lamp.

Lamp holder module 3000 may include enclosure 3008. Enclosure 3008 may enclose a portion of the components included in lamp holder module 3000. Alternately, enclosure 3008 may enclose all of the components included in lamp holder module 3000. Lamp holder module 3000 may further include fastening feature 3010. Fastening feature 3010 may facilitate the attachment of lamp holder module 3000 to a lamp fixture housing.

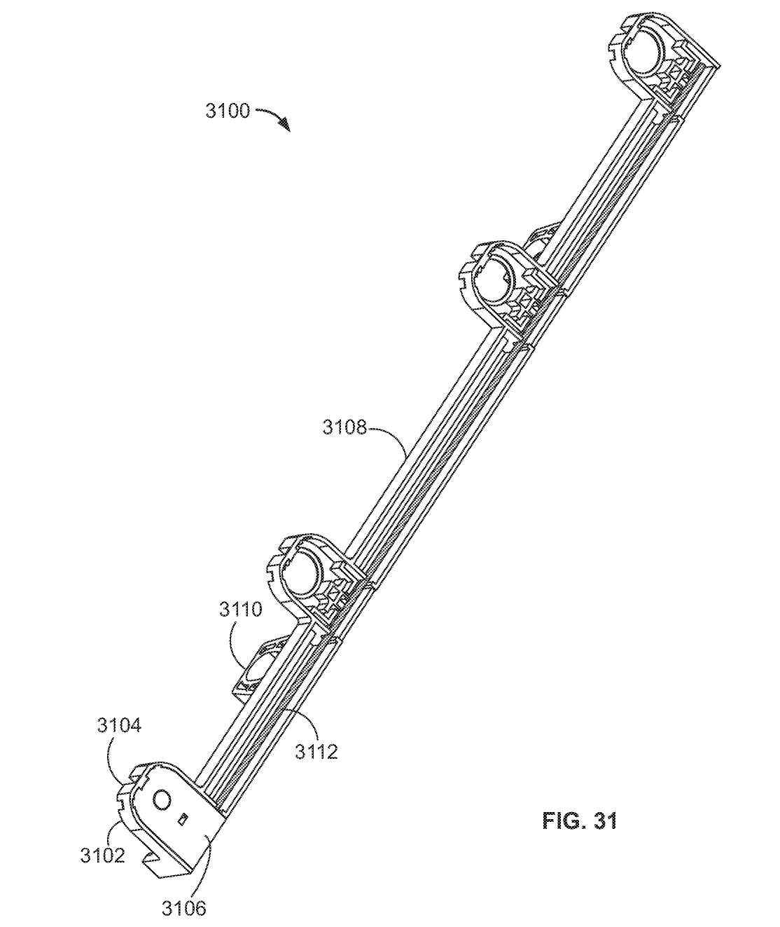

FIG. 31 shows a portion of illustrative lamp holder module 3100. Lamp holder module 3100 may include lamp holders 3102, lamp pin guide 3104, pin slot 3106, enclosure 3108 and fastening feature 3110. Lamp holder module 3100 may include conductor 3112. Conductor 3112 may be used to power a fluorescent lamp supported by lamp holder 3102.

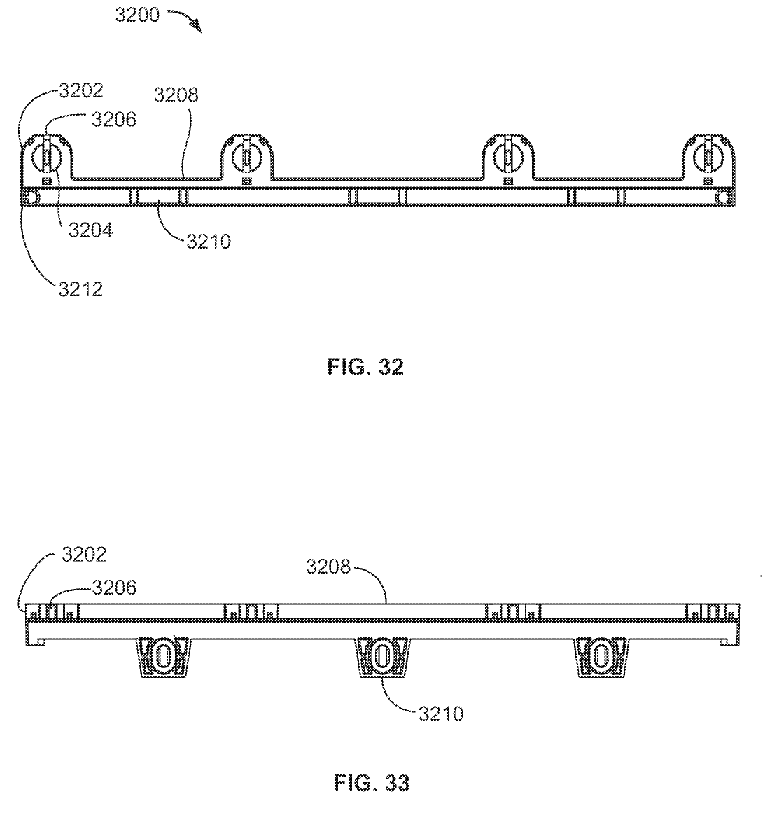

FIG. 32 shows a frontal view of illustrative lamp holder module 3200. Lamp holder module 3200 may include lamp holders 3202, lamp pin guide 3204, pin slot 3206, enclosure 3208 and fastening feature 3210. Lamp holder module 3200 may additionally include conductors 3212.

FIG. 33 shows a plan view of lamp holder module 3200.

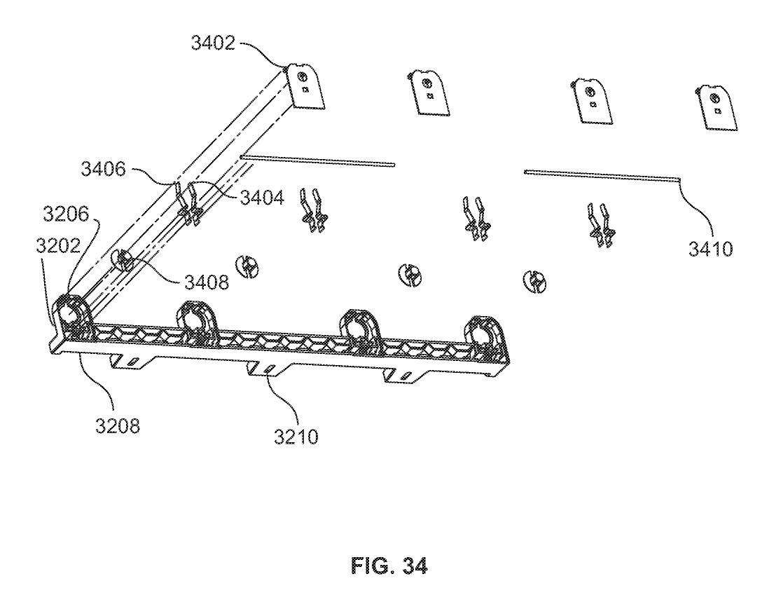

FIG. 34 shows an exploded perspective view of lamp holder module 3200. Lamp holder module 3200 may include cover 3402. Cover 3402 may enclose components present in lamp holders 3202. Lamp holder module 3200 may additionally include right contact 3404, left contact 3406, rotor 3408 and conductor 3410. These components may enable a fluorescent lamp to be supported and/or powered by lamp holder 3202.

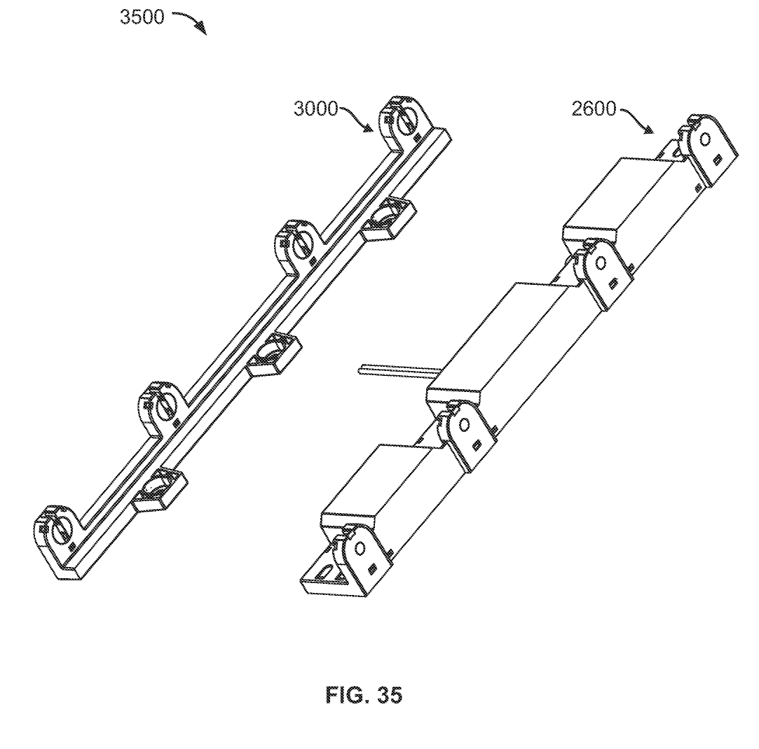

FIG. 35 shows illustrative arrangement 3500 that includes ballast module 2600 and lamp holder module 3000. Arrangement 3500 may represent the relative positions of ballast module 2600 and lamp holder module 3000 when fixed to a housing.

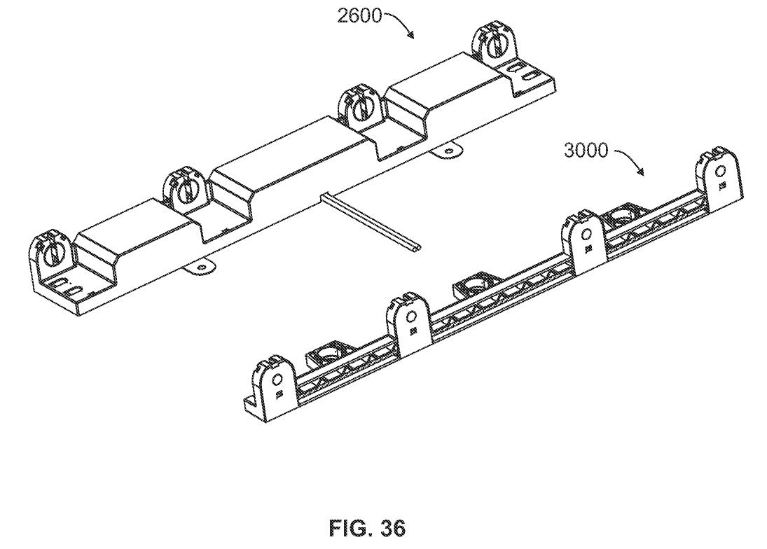

FIG. 36 shows a perspective view of arrangement 3500.

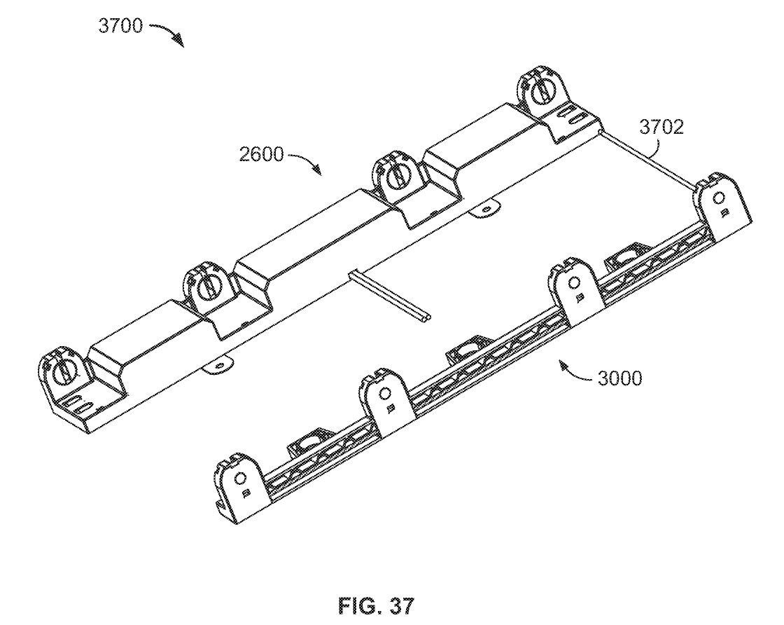

FIG. 37 shows illustrative arrangement 3700 that includes ballast module 2600 and lamp holder module 3000. Illustrative arrangement 3700 includes conductor 3702. Conductor 3702 may be in electrical contact with ballast module 2600 and lamp holder module 3000. Arrangement 3700 may represent the relative positions of ballast module 2600 and lamp holder module 3000 when fixed to a housing.

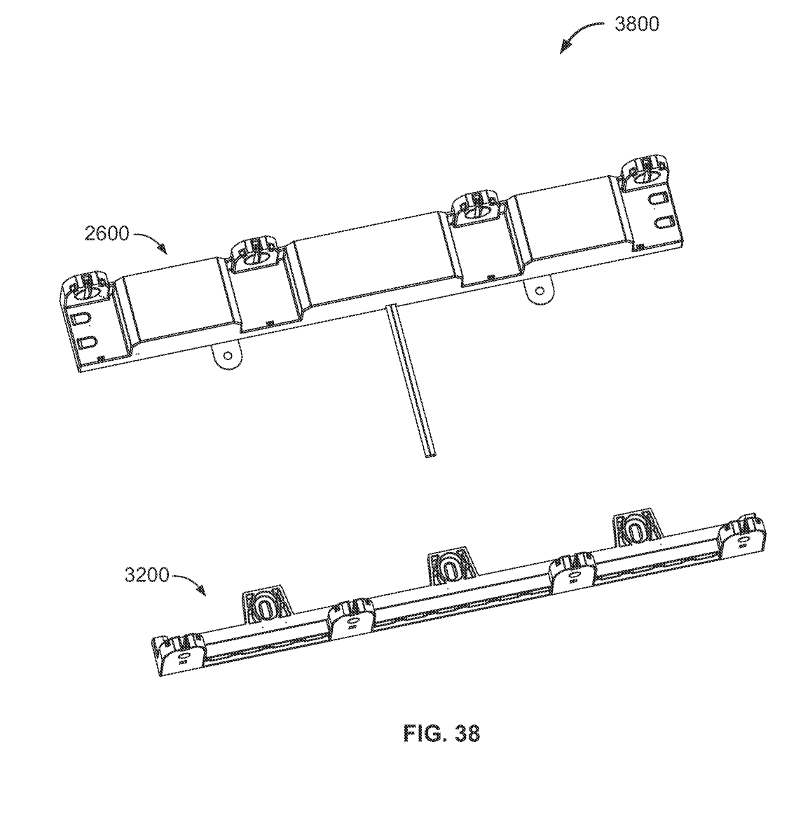

FIG. 38 shows illustrative arrangement 3800 that includes ballast module 2600 and lamp holder module 3200. Arrangement 3800 may represent the relative positions of ballast module 2600 and lamp holder module 3200 when fixed to a housing.

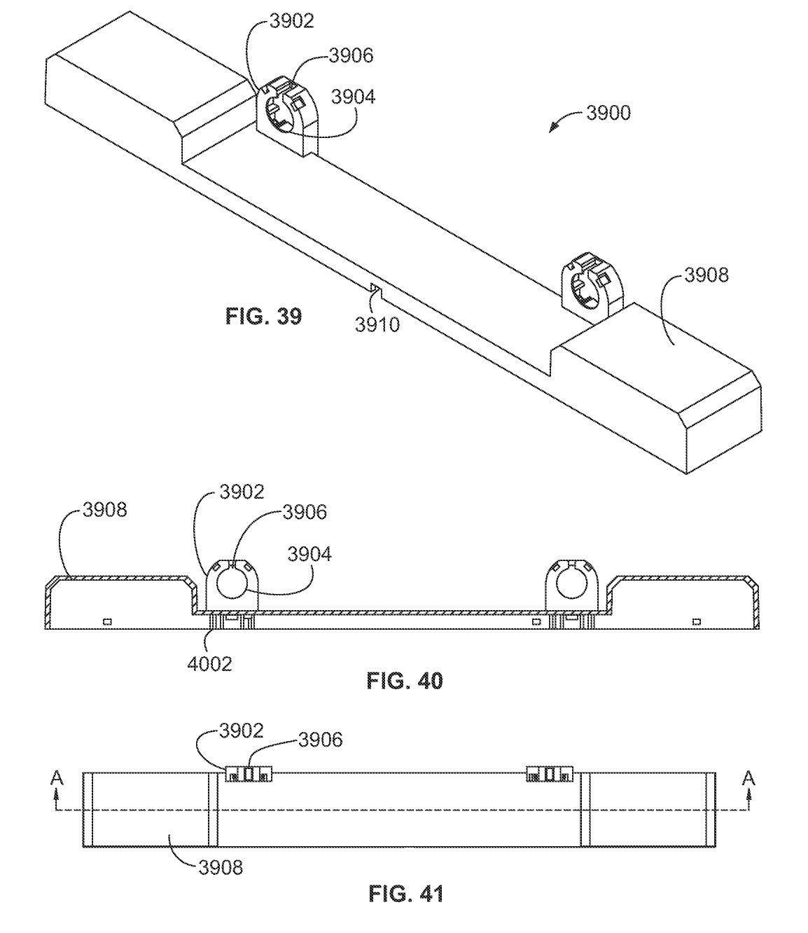

FIG. 39 shows illustrative retrofit ballast module 3900. Retrofit ballast module 3900 may be configured replace one or more functionalities of a previously installed ballast module. Retrofit ballast module 3900 may include lamp holders 3902, lamp pin guide 3904 and pin slot 3906. Retrofit ballast module 3900 may additionally include ballast cover 3908. Retrofit ballast module 3900 may also include opening 3910. Power lines may pass through opening 3910 and connect to a suitable voltage source.

FIG. 40 shows a partial cross-sectional view of retrofit ballast module 3900. Retrofit ballast module 3900 may include connector 4002. Connector 4002 may secure lamp holder 3902 to the base of retrofit ballast module 3900.

FIG. 41 shows a plan view of retrofit ballast module 3900.

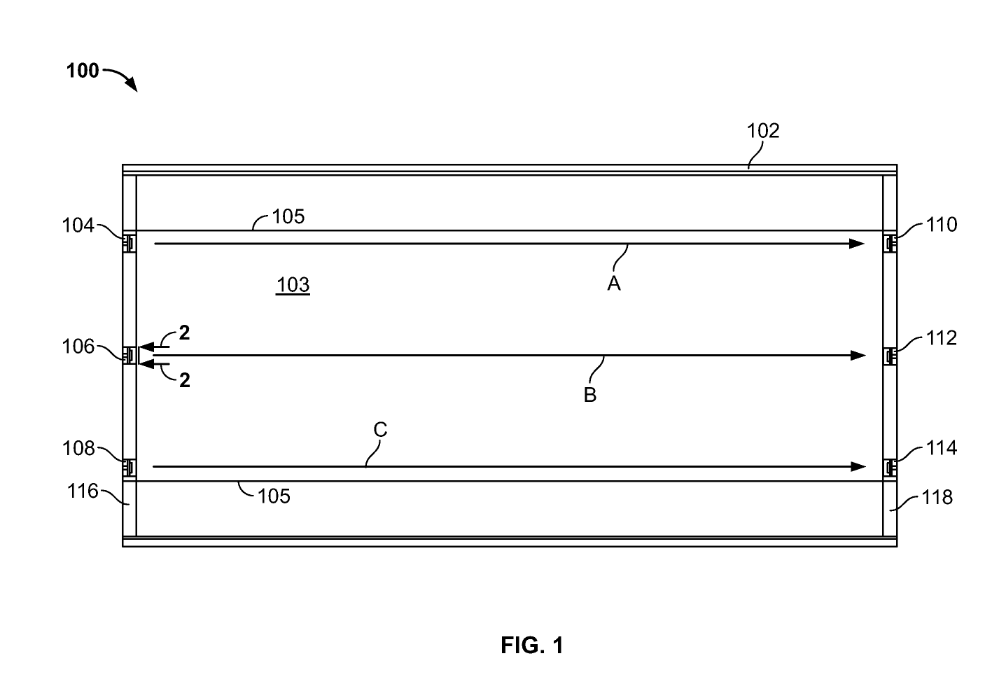

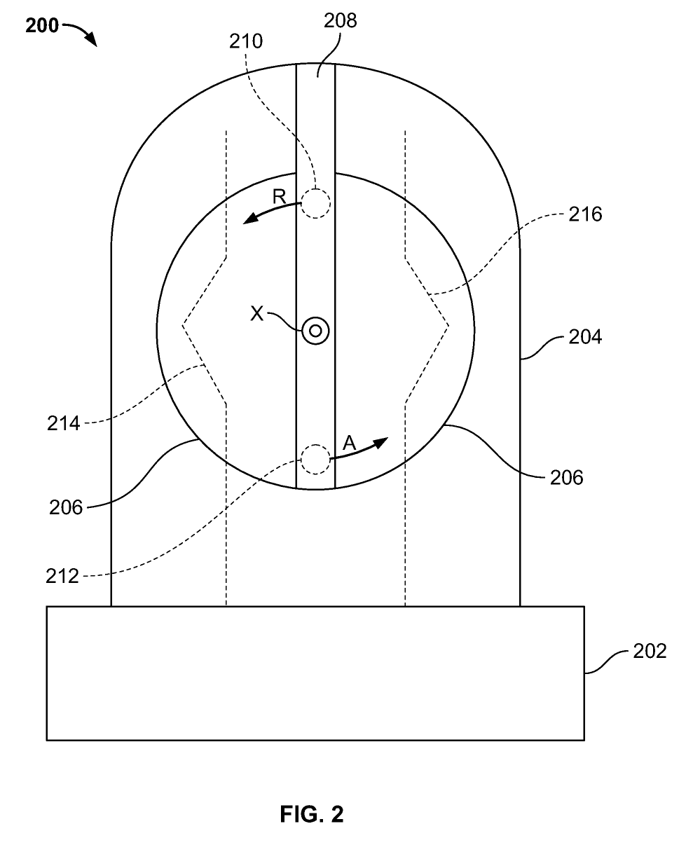

It will be appreciated that features of apparatus shown and described in connection with only one or more of FIGS. 1-41 may be combined with features shown and described in connection with any one or more of the other FIGS. For example, apparatus and methods for supporting a lamp holder may be combined in any suitable manner with apparatus and methods for connecting a lamp holder to a ballast.

Thus, apparatus and methods for supporting and energizing a lamp have been provided. Persons skilled in the art will appreciate that the present invention can be practiced by other than the described embodiments, which are presented for purposes of illustration rather than of limitation, and the present invention is limited only by the claims which follow.

What is claimed is:

1. An integrated ballast module comprising:
a ballast; and
a housing having an exterior and an interior; wherein:
the housing is configured to support two or more lamp holders exterior to the housing; and
the ballast is located in the interior of the housing.

2. The apparatus of claim 1 wherein the two or more lamp holders are coupled to the exterior of the housing.

3. The apparatus of claim 2 wherein the two or more lamp holders are removably coupled to the exterior of the housing.

4. The apparatus of claim 2 wherein the two or more lamp holders and a portion of the exterior of the housing form a unitary structure.

5. The apparatus of claim 1 wherein the integrated ballast module is configured to be attached to a lamp fixture to replace a previously installed ballast, wherein the previously installed ballast is not configured to support a lamp holder.

6. The apparatus of claim 2 wherein:
the ballast comprises ballast components that are connected to a printed circuit board and extend away from the printed circuit board; and
the printed circuit board is disposed in the interior of the housing.

7. The apparatus of claim 6 further comprising, for each of the lamp holders, a conductor for placing the lamp holder in electrical communication with the ballast components.

8. The apparatus of claim 7 wherein the conductor is a wire.

9. The apparatus of claim 7 wherein the conductor is a flat cable.

10. The apparatus of claim 1 wherein the exterior of the housing includes a fastener to fix the integrated ballast module to a lamp fixture housing.

11. The apparatus of claim 10 wherein the fastener includes a captive screw.

12. The apparatus of claim 10 wherein the fastener includes a metal tab.

13. A lamp fixture comprising:
a first module including:
a first housing having an exterior and an interior;
first lamp holders coupled to the first housing; and
a ballast located in the interior of the first housing;
a second module including:
a second housing having an exterior and an interior;
second lamp holders coupled to the second housing; and
second module conductors configured to provide power to the second lamp holders;
an enclosure; and
a conductor; wherein:
the first module is fixed to the enclosure at a distance from the second module;
the distance corresponds to a nominal fluorescent lamp length; and
the conductor extends from the first module to the second module.

14. The apparatus of claim 13 wherein a portion of the first housing and portions of the first lamp holders form a unitary structure.

15. The apparatus of claim 13 wherein a portion of the second housing and portions of the second lamp holders form a unitary structure.

16. The apparatus of claim 13 wherein the first lamp holders are removably coupled to the first housing.

17. The apparatus of claim 13 wherein the second lamp holders are removably coupled to the second housing.

18. An integrated ballast module comprising:
a housing; and
a printed circuit board inside the housing, the printed circuit board having a component side, the printed circuit board having:
a first region that includes a first ballast electrical component that is mounted on the component side and extends away from the component side;
a second region; and
a third region that includes a second ballast electrical component that is mounted on the component side and extends away from the component side; wherein the housing has:
a first portion that provides clearance inside the housing for the first electrical ballast component;
a second portion that provides clearance outside the housing for a fluorescent lamp; and
a third portion that provides clearance inside the housing for the second electrical ballast component.

19. The apparatus of claim 18 wherein the housing includes a daylight sensor.

20. The apparatus of claim 18 wherein the housing includes an occupancy sensor.

21. The apparatus of claim 18 wherein the printed circuit board includes an emergency ballast component.

22. The apparatus of claim 18 wherein the printed circuit board includes an instant start ballast component.

23. The apparatus of claim 18 wherein the printed circuit board includes a rapid start ballast component.

24. The apparatus of claim 18 wherein the printed circuit board includes a programmed rapid start ballast component.

25. The apparatus of claim 18 wherein the printed circuit board includes a dimming ballast component.

26. The apparatus of claim 18 further comprising a lamp holder supported by the housing and configured to support the fluorescent lamp adjacent the second portion.

27. A method for assembling a lamp fixture, the method comprising:
attaching a ballast module to a lamp fixture enclosure; and
attaching a lamp holder module to the lamp fixture enclosure at a distance from the ballast module, the distance corresponding to a nominal lamp-length; wherein:
the ballast module includes first lamp holders; and
the lamp holder module includes second lamp holders.

28. The method of claim 27 further including connecting a conductor that extends from the ballast module to the lamp holder module.

29. The method of 28 wherein the attaching of the ballast module to the sheet metal fixture, the attaching of the lamp holder module to the sheet metal fixture, and the connecting of the conductor therebetween, is sufficient to provide a circuit that is configured to transmit ballasted power from an external power source to the lamp.

30. The method of claim 27 further comprising removing a pre-installed ballast from the sheet metal enclosure, wherein:
the pre-installed ballast is a ballast that does not directly support lamp holders; and
the enclosure is installed in a structure configured for occupancy.

31. A method for manufacturing a ballast housing for a fluorescent lamp, the method comprising:
forming a thermoplastic housing, the thermoplastic housing having at least one internal region for ballast components and at least one external region for fluorescent tube clearance.

32. An integrated ballast module comprising:
a ballast;
a housing having an exterior and an interior; and
a lamp holder; wherein:
lamp holder is removably coupled to the exterior of the housing; and
the ballast is located in the interior of the housing.
